(19) United States
(12) Patent Application Publication
(10) Pub. No.: US 2024/0156188 A1
(43) Pub. Date: May 16, 2024

(54) FILTRATION GARMENTS

(71) Applicant: MYANT INC., Toronto (CA)

(72) Inventors: Tony CHAHINE, Toronto (CA); Milad ALIZADEH-MEGHRAZI, Toronto (CA); Ladan ESKANDARIAN, Toronto (CA); Sahar GOLMOHAMMADI ROSTAMI, Toronto (CA); Samuele AMADIO, Gazzo (IT)

(21) Appl. No.: 18/284,016

(22) PCT Filed: Dec. 16, 2021
(86) PCT No.: PCT/CA2021/051821

§ 371 Date: Sep. 25, 2023

Related U.S. Application Data
(60) Provisional application No. 63/165,591, filed on Mar. 24, 2021.

(51) Int. Cl. A41D 13/11; A62B 23/02

(52) U.S. Cl. CPC A41D 13/1138; A62B 23/025; B01D 2239/0428; B01D 2239/0659; B01D 2239/1208; B01D 2239/1233

(57) ABSTRACT

A facial garment. The facial garment may include an outer hydrophobic textile for repelling moisture, an inner textile proximal to the outer hydrophobic textile, and an interconnecting structure coupling the outer hydrophobic textile and the inner textile. The interconnecting structure may include nylon-wrapped, synthetic elastane fiber. The inner textile may include a natural fiber having one or more neps for increasing an interaction surface area for particles incident on the facial garment and for promoting turbulence among particles incident on the facial garment.

### CROSS REFERENCE TO RELATED APPLICATIONS

This application claims priority from U.S. provisional patent application No. 63/165,591, entitled “FILTRATION GARMENTS”, filed on Mar. 24, 2021, the entire contents of which are hereby incorporated by reference herein.

### FIELD

The present disclosure generally relates to filtration textiles, and in particular to filtration garments.

### BACKGROUND

Personal protective equipment (PPE) may include articles of clothing or devices used to provide a barrier between a user and viral/bacterial specimens, dust, smoke, or other substances foreign to the user. Personal protective equipment may include medical gloves, gowns, aprons, face masks, face shields, hazmat suits, among other example garments. In some examples, personal protective equipment may be intended to be one-time use garments. In some other examples, personal protective equipment may be intended to be sterilized, laundered, or otherwise processed for multiple uses/re-uses.

### SUMMARY

The present disclosure provides personal protective garments including features to filter particles having a range of particle sizes whilst maintaining garment breathability. As a non-limiting example, personal protective garments may include facial garments adaptable to cover an oral-nasal region when the facial garment is worn by the user.

In some embodiments, the facial garments described herein may be configured to filter particles having a range of particle sizes based on filtration efficiency metrics whilst maintaining breathability metrics according to testing standards provided by the American Society for Testing and Materials (ASTM), the National Institute of Occupational Safety and Health (NIOSH), among other standards organizations.

In some scenarios, filtration efficiency may be correlated with textile fibre type, textile mass, garment stitching length, or knitting structure according to non-linear or complex relations. For example, configuring a textile garment having a high fiber/yarn count with short stich lengths and low porosity may neither provide desirably high filtration efficiency nor breathability. A general trend or relation correlating material yarn count and garment stitch length with filtration efficiency may not exist.

Amidst publically declared health pandemics (e.g., COVID-19 pandemic) or day-to-day activities in non-optimal environmental conditions (e.g., where it may be desirable to provide a barrier between a user and potentially hazardous substances), it may be beneficial to provide facial garments for optimizing filtration efficiency of particles having a range of particle sizes according to standards thresholds (e.g., ASTM F2100 filtration efficiency thresholds) while maintaining breathability according to standards thresholds (e.g., NIOSH breathability thresholds).

In some scenarios, users may frequently wear filtration garments. When single-use personal protective equipment may be used, high volume of discarded garments may result in copious waste thereby contributing to landfill waste. It may be beneficial to provide facial garments configured to provide desirable filtration efficiency of particles having a range of particle sizes desirable breathability to the user, whilst maintaining such functionality following numerous laundering/washing and drying cycles.

In an aspect, the present disclosure describes a facial garment comprising an outer hydrophobic textile for repelling moisture; an inner textile proximal to the outer hydrophobic textile; and an interconnecting structure coupling the outer hydrophobic textile and the inner textile. The interconnecting structure may include nylon-wrapped, synthetic elastane fiber. The inner textile may include a natural fiber having one or more neps for increasing an interaction surface area for particles incident on the facial garment and for promoting turbulence among particles incident on the facial garment.

In some embodiments, the natural fiber may be devoid of synthetic fibers.

In some embodiments, the inner textile may include up to 3-ended cotton ends.

In some embodiments, the inner textile may be a 3-ended cotton textile.

In some embodiments, the inner textile may include 3× cotton textile, and the outer hydrophobic textile 150 may include 2× super-hydrophobic polyester.

In some embodiments, wherein the natural fiber includes a range of cross-sectional fiber diameter variability in the range of 20 μm.

In some embodiments, a stich length associated with the outer hydrophobic textile may be 0.58 millimeters, and a stitch length associated with the inner textile may be 0.61 millimeters.

In some embodiments, a thickness of the combined outer hydrophobic textile and the inner textile may be substantially 2.67 millimeters, and an areal mass of the combined outer hydrophobic textile and the inner textile may be substantially 0.0245 g/cm².

In some embodiments, the outer hydrophobic textile may be configured to interact with an incident particle at an environment facing surface of the outer hydrophobic textile at a contact angle of substantially 160 degrees.

In some embodiments, the interconnecting structure may draw moisture in a unitary direction from the inner textile to the outer hydrophobic textile.

In some embodiments, the facial garment may include at least one of a nose bridge device or a chin bridge device for positioning the facial garment to contours of a user's face.

In some embodiments, the inner textile includes a natural fiber having a web structure.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a perspective view of a facial garment adapted to cover an oral-nasal region, in accordance with embodiments of the present disclosure;

FIG. 2 illustrates an exploded, rear perspective view of the facial garment of FIG. 1;

FIG. 3A illustrates an exploded, front perspective view of the facial garment of FIG. 1;

FIG. 3B illustrates an exploded, perspective view of a hybrid multilayer facial garment having features for aerosol filtration, in accordance with embodiments of the present disclosure;

FIG. 4 illustrates a system configured for testing facial garments, in accordance with embodiments of the present disclosure;

FIG. 5 illustrates a water droplet at a textile surface, in accordance with an embodiment of the present disclosure;

FIGS. 6 to 8 illustrate features of numerous samples having varying composition and varying textile layer features, in accordance with embodiments of the present disclosure;

FIG. 9 illustrates a chart showing pressure drop as a function of yarn count, in accordance with an embodiment of the present disclosure;

FIG. 10 illustrates a chart showing pressure drop as a function of stitch length, in accordance with an embodiment of the present disclosure;

FIG. 11 illustrates a chart showing pressure drop as a function of porosity, in accordance with embodiments of the present disclosure;

FIG. 12 illustrates a chart showing pressure drop as a function of sample thickness, in accordance with embodiments of the present disclosure;

FIG. 13 illustrates a chart showing change in pressure for a plurality of samples, in accordance with embodiments of the present disclosure;

FIG. 14 illustrates a chart showing filtration efficiency for particles in the 100 to 250 nm range, in accordance with embodiments of the present disclosure;

FIG. 15 illustrates a chart showing filtration efficiency for particles in the 250 nm to 1 μm range, in accordance with embodiments of the present disclosure;

FIG. 16 illustrates a chart showing quality factor values for a plurality of facial garment textile samples, in accordance with embodiments of the present disclosure;

FIG. 17 illustrates a chart showing filtration efficiency as a function of particle size for a plurality of samples, in accordance with embodiments of the present disclosure;

FIG. 18 illustrates a chart showing effect of porosity on a minimum filtration efficiency, in accordance with embodiments of the present disclosure;

FIG. 19 illustrates a chart showing effect of a number of cotton ends on filtration efficiency, in accordance with embodiments of the present disclosure;

FIGS. 20A and 20B illustrate enlarged views of a sample cotton textile and a scanning electron microscope image of the sample cotton textile, respectively, in accordance with embodiments of the present disclosure;

FIGS. 21A and 21B illustrate enlarged views of a combination of cotton+nylon textile and a scanning electron microscope image of the combination cotton+nylon textile, in accordance with embodiments of the present disclosure;

FIG. 22 illustrates a schematic of a fabric knitted based on natural fibers, in accordance with embodiments of the present disclosure;

FIG. 23 illustrates a schematic of a cotton fiber showing neps and hair, in accordance with embodiments of the present disclosure;

FIG. 24 illustrates a chart showing effect of yarn count on filtration efficiency, in accordance with embodiments of the present disclosure;

FIG. 25 illustrates a chart showing effect of thickness on filtration efficiency, in accordance with embodiments of the present disclosure;

FIG. 26 illustrates a chart showing effect of porosity on filtration efficiency, in accordance with embodiments of the present disclosure;

FIG. 27 illustrates a chart showing effect of stitch length on filtration efficiency, in accordance with embodiments of the present disclosure;

FIG. 28 illustrates a chart showing filtration efficiency for particles having size in the range 250 nm to 1 μm after a plurality of textile wash cycles, in accordance with embodiments of the present disclosure;

FIG. 29 illustrates a chart showing filtration efficiency for particles having size in the range 100 to 250 nm after a plurality of textile wash cycles, in accordance with embodiments of the present disclosure;

FIG. 30 illustrates a chart showing a change in pressure across a textile after a plurality of textile wash cycles, in accordance with embodiments of the present disclosure;

FIG. 31 illustrates a chart showing porosity as a function of number of wash cycles, in accordance with embodiments of the present disclosure; and

FIG. 32 illustrates a sample knitting diagram, in accordance with embodiments of the present disclosure.

### DETAILED DESCRIPTION

As an illustrating scenario, after the rapid spread of SARS-Cov-2 virus, the use of facial garments were suggested by the world health organization (WHO) to reduce virus transmission. A predominant mode of transmission may be through respiratory droplets. In some scenarios, recommended face coverings were single use surgical and respirator masks constructed of non-woven materials. With increased demand for facial garments worldwide, the environmental impacts of facial garment disposal and the pollution caused by micro-plastic fibers of the non-woven materials was exacerbated. It may be beneficial to provide facial garments that may be reusable, thereby reducing undesirable effects to the environment while providing a user with beneficial personal protective features.

In some embodiments described in the present disclosure, facial garments may include features in accordance with ASTM F2299 specifications. For example, facial garments disclosed herein may include features evaluated based on particle-size dependent filtration efficiency and pressure drop/change across the facial garment textile. In some embodiments, facial garments may include multilayer knit fabrics of natural or synthetic fibers. For example, an inner layer may be constructed of pure cotton, cotton-nylon, or cotton-polyester. A middle or interconnecting layer may be constructed of Lycra™. An outer layer may be constructed of super-hydrophobic polyester. In some embodiments, facial garments described herein may have a filtration efficiency of >97.3% for large particles and 89.9% to 98.4% for fine particles.

In some embodiments, facial garments described herein may be constructed of a textile having a composition of 41% super-hydrophobic polyester, 26% natural cotton, 24% nylon and 9% Lycra, providing an evaluated filtration efficiency of approximately 97.8% for 100 nm particles, a pressure drop across the textile of approximately 4.04 mmH₂O/cm², and a quality factor of approximately 4.77 kPa⁻¹. In some embodiments, facial garments described herein may maintain performance metrics after up to 50 wash/dry cycles, thereby showing reusability of the facial garment. It was also demonstrated that the developed mask maintained its performance after 50 wash/dry cycles, verifying reusability of facial garments described herein.

Embodiments of facial garments will be described in the present disclosure.

The environment may include one or more types of materials in one or more of a solid, liquid, or gaseous form that may be harmful to a user's respiratory system, or other organs. In some scenarios, it may be beneficial for a user to don filtration garments, such as a facial garment. For example, a facial garment may be adapted to cover an oral-nasal region when the facial garment is worn by the user.

In scenarios when a user may wish to frequently wear garments or textiles configured to provide filtration of particles or to act as a barrier to particles foreign to the user, the user may utilize numerous single-use or disposable facial garments over time. Use of single-use garments may generate copious waste, thereby contributing to environmental pollution. It may be beneficial to provide filtration garments that may be laundered (e.g., washed and dried) whilst maintaining the filtration garment's filtration properties.

Further, as filtration garments may be worn adjacent a user's skin or adjacent the user's respiratory system, it may be beneficial to provide filtration garments that may be breathable (e.g., maximize user comfort) whilst maintaining features for providing a filtration barrier to particles having a range of particle sizes. It may be beneficial to provide reusable filtration garments that may be laundered, and that may conform to industry standards (e.g., ASTM, NIOSH, among other regulatory organizations providing technical standards for materials) subsequent to numerous washing and drying cycles.

As will be described in the present disclosure, a general trend or relation for correlating textile yarn count and garment stitch length with filtration efficiency may not exist. Further, mechanisms for filtering relatively larger particles (e.g., >20 μm) and mechanisms for filtering relatively smaller particles (e.g., <20 μm) may be different.

Embodiments of the present disclosure provide filtration garments having features that may provide a filtration efficiency according to industry technical standards for a wide range of particle sizes. Further, the present disclosure provides filtration garments having features that may provide breathability according to industry technical standards while maintaining a desirable filtration efficiency for the wide range of particle sizes. In addition, the present disclosure provides filtration garments that may be laundered a plurality of cycles, whilst not presenting substantial degradation in filtration efficiency and breathability properties that are disclosed herein.

For ease of exposition, the present disclosure describes facial garments. It may be understood that filtration garments may include other types of non-facial garments, such as gloves, gowns, hazmat suits, shirts, undergarments, among other examples.

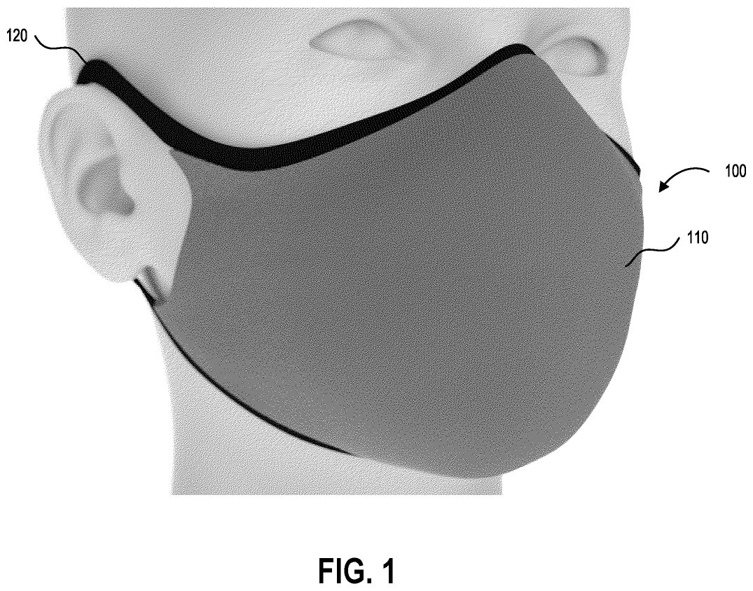

Reference is made to FIG. 1, which illustrates a perspective view of a facial garment 100 adapted to cover an oral-nasal region when the facial garment 100 is worn by the user, in accordance with embodiments of the present disclosure. The facial garment 100 may include a combination of textiles to form a filtration body 110.

The facial garment 100 may include one or more attachment members 120 for positioning the filtration body 110 to the user. In some embodiments, the one or more attachment members 120 may be textile loops for wrapping around one or more of the user's ears. In some embodiments, the one or more attachment members 120 may be configured to wrap around other portions of a user's head or the user's body.

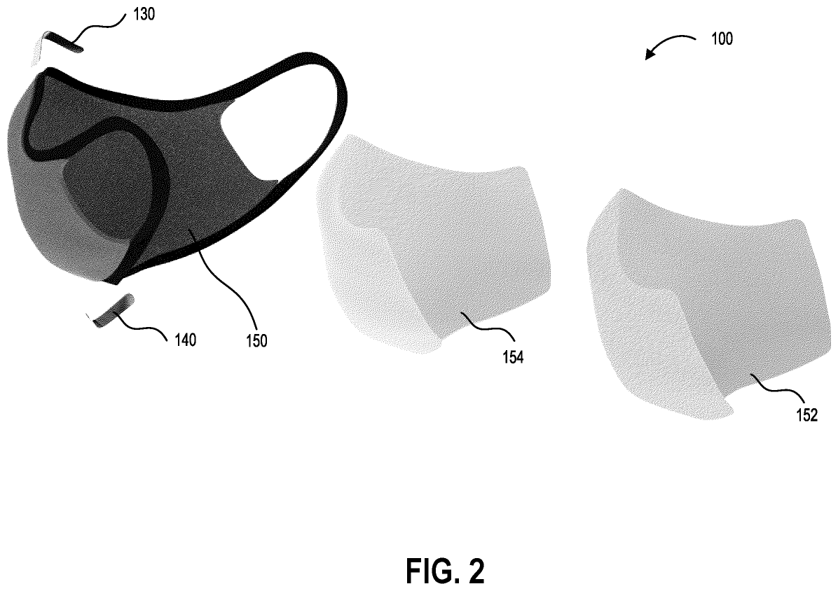

Reference is made to FIG. 2, which illustrates an exploded, rear perspective view of the facial garment 100 of FIG. 1. In some embodiments, the facial garment 100 may include at least one of a nose bridge 130 or a chin bridge 140. The nose bridge 130 or the chin bridge 140 may be constructed of malleable material, and the user may shape the nose bridge 130 or the chin bridge 140 for improving fitment of the facial garment 100 against the user's face.

In some embodiments, the facial garment 100 may include a filtration body having an outer hydrophobic textile 150 for repelling moisture, an inner textile 152 proximal to the outer hydrophobic textile 150, and an interconnecting structure 154 coupling the outer hydrophobic textile 150 and the inner textile 152.

In the illustration of FIG. 2, the interconnecting structure 154 is illustrated as a discrete textile layer. In some other embodiments, the interconnecting structure 154 may be an integrated structure assembled when coupling the outer hydrophobic textile 150 and the inner textile 152.

In some embodiments, the interconnecting structure 154 may be for plating, and may be configured to bond the outer hydrophobic textile 150 with the inner textile 152. In some embodiments, the interconnecting structure 154 may be constructed of nylon-wrapped Lycra™ yarn. For example, nylon-wrapped Lycra™ may be nylon-wrapped, synthetic elastane fiber. The interconnecting structure 154 may create a uni-directional wicking feature allowing transfer or wicking of moisture in a single direction. For example, the interconnecting structure 154 may be configured to allow wicking of moisture in a direction from the inner textile 152 to the outer hydrophobic textile 150.

The outer hydrophobic textile 150 may be constructed of a “stay dry” super-hydrophobic polyester yarn for wicking away moisture/humidity, thereby providing an initial barrier to foreign particles. For example, in a medical clinic context, the outer hydrophobic textile 150 may form a surface filtration barrier that may repel aerosol particles, blood, or other fluids from adhering to the outer surface.

In some embodiments, the outer hydrophobic textile 150 may be constructed of 2× super-hydrophobic polyester textiles. Other configurations of the outer hydrophobic textile 150 may be contemplated. Further examples are provided in the present disclosure.

The inner textile 152 may be constructed of cotton yarn, which may be a heterogeneous material having a fibrillary structure. In some embodiments, respective yarn strands may include a plurality of individual cotton fibers which may be coupled together by a twist configuration. In some embodiments, a cotton yarn construction may improve user comfort and provide hypoallergenic features, thereby providing reduced skin irritation from extended time contact with the user's skin.

Based on the foregoing, in some embodiments, the inner textile 152 may include a natural fiber having a nep for increasing an interaction surface for particles incident on the facial garment and for promoting turbulence among particles incident on the facial garment.

In some embodiments, to increase the filtration efficiency of the facial garment 100, the inner textile 152 may be devoid of synthetic fibers. As synthetic fibers, such as nylon fibers, may have a uniform fiber cross-sectional diameter and a general absence of neps, natural fibers (e.g., PFD cotton yarns) contribute to increased filtration efficiency at least because natural fibers may include neps and have varied fiber cross-sectional diameters.

In some embodiments, the natural fiber may include a plurality of fibers having a range of cross-sectional fiber diameter variability in the range of 20 μm.

In some embodiments, the inner textile 152 may be a 3-ended cotton textile. As will be described in the present disclosure, increasing the number of cotton textile ends may not result in increasing filtration efficiency. In some scenarios, increasing the number of cotton textile ends may reduce filtration efficiency.

In some embodiments, a stitch length associated with the outer hydrophobic textile may be approximately 0.58 millimeters. In some embodiments, a stitch length associated with the inner textile may be approximately 0.61 millimeters.

In some embodiments, the thickness of the combined outer hydrophobic textile and the inner textile may be substantially 2.67 millimeters. In some embodiments, an area mass of the combined outer hydrophobic textile and the inner textile may be substantially 0.0245 g/cm².

In some embodiments, the outer hydrophobic textile 150 may be configured to interact with an incident particle at an environment facing surface at a contact angle of substantially 160 degrees.

Features of some embodiments of the combined inner textile 152, outer hydrophobic textile 150, and the interconnecting structure 154 are provided above for providing a facial garment 110 that may adhere to at least one of filtration efficiency standards of ASTM F2100 or breathability standards of NIOSH. Other facial textile features and configurations described in the present disclosure for meeting filtration efficiency standards or breathability standards may be contemplated.

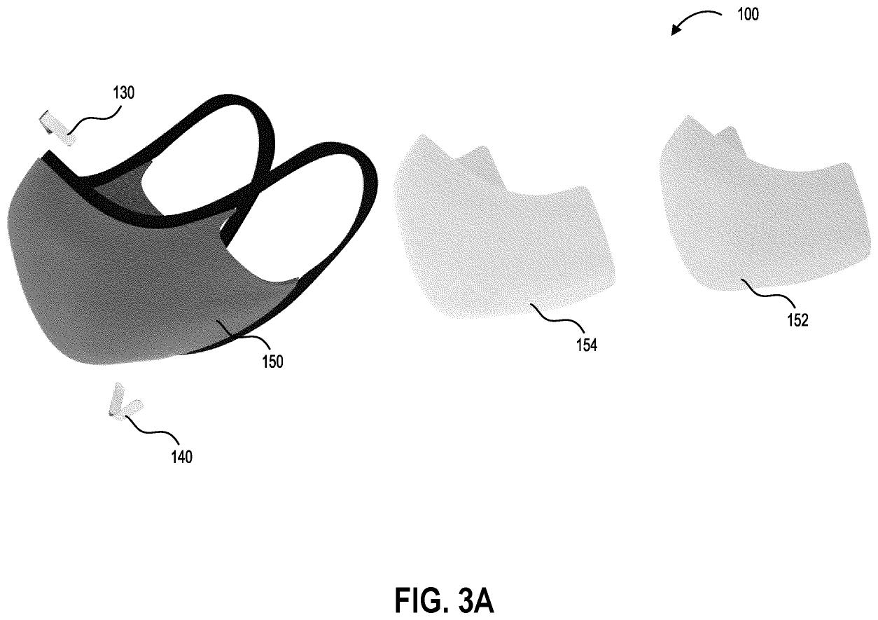

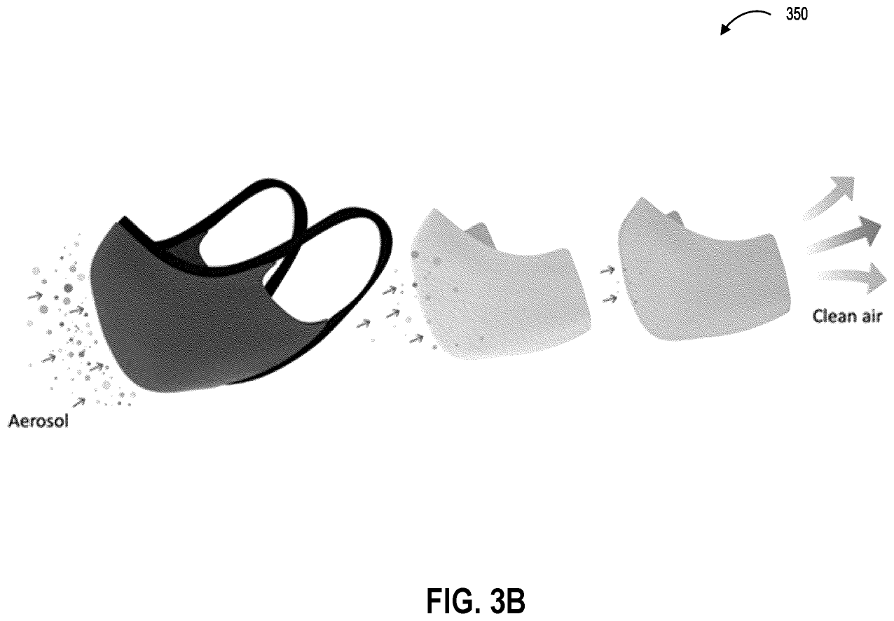

Reference is made to FIGS. 3A and 3B, which illustrate an exploded, front perspective view of the facial garment 100 of FIG. 1, and a perspective view of a hybrid multilayer facial garment 350 having features of aerosol filtration, in accordance with embodiments of the present disclosure.

In the disclosure that follows, for ease of exposition, embodiments of facial garments may be described as having application during times of global health pandemics, such as the pandemic of coronavirus (COVID-19) may be described. It may be understood that embodiments of facial garments other types of environments where facial garments may be beneficial for protecting a user's respiratory system or other organs from environmental factors or materials may be contemplated.

The pandemic substantially caused by coronavirus disease (COVID-19) believed to be caused by severe acute respiratory syndrome coronavirus 2 (SARS-CoV-2) has put the global health in risk [1]. When infected, the coronavirus may cause one or more symptoms ranging from mild to severe respiratory injury to digestive, genital and cardiovascular system damage [2][3].

In some scenarios, respiratory droplet transmission and contact with infected droplets may be contributing factors causing spread of COVID-19 [4][5]. In some scenarios, people may breath, sneeze, or cough, thereby generating droplet that may have a distribution of droplet size (0.01 μm up to 1000 μm) [6][7][8]. Relatively larger droplets (1-6 μm) may be generated based on voiced activities such as speaking and whispering. Concentration of relatively larger droplets may increase based on increasing speech volume or loudness. Larger droplets may be generated by coughing and sneezing (˜200 μm). Further, droplets having approximate diameter of >20 μm, which are formed by saliva, may descend to the ground due to gravity within a few seconds or within a few minutes and may not project or travel more than 1-2 m [6][7][8].

Relatively smaller droplets may be generated by breathing and droplet size may decrease in size by 30-50% of its initial size due to evaporation [7][9][10][11]. Smaller droplets having size of ˜3 μm, which are mainly formed by the mucous coating of the lungs and vocal cords and are invisible to the naked eye, may be associated with relatively longer settling times, thereby suspending or lingering in air for several minutes or hours before descending to the ground. In some scenarios, fine droplets may travel for more than 9 meters and may contribute to a spread of the virus in indoor environments [12]. As described by Yan et al., activities associated with breathing and talking may generate infectious fine droplets that can be transferred via moist and warm aerosol [13]. In some environments, particles having diameters in the range of 350-500 nm may contain COVID-19 virus that can stay viable for one or more hours [14][15].

To reduce the risk of particle transmission and to reduce occurrences of inhalation of particles, it may be beneficial for users to utilize a facial garment or other personal protective equipment (PPE) [16]. A facial garment may be configured to be positioned about a user's nose or mouth and may be configured to provide a barrier to reduce exposure to particles or droplets. Further, a facial garment may be configured to reduce transmission of respiratory secretions of the user to an environment.

In some scenarios, a filter fiber may be configured to collect the particles and retain such particles based on Van Der Waals forces [17]. However, designing a facial garment having features for filtration and features for breathability may be challenging, at least, because environment particles may be of varying sizes. For example, environment particles may range in size having diameters from 0.1-100 μm. It may be beneficial to improve filtration efficiency or breathability efficiency based on design of filtration medium.

In some embodiments, mechanisms for trapping or removing particles may include factors including: inertial impaction (Eᵢ), interception (E_{R}), diffusion (E_{D}), and electrostatic attraction (E_{B}) [18][19]. Inertial impaction may be beneficial when particles or droplets may be larger than 1 μm and have sufficiently high inertia. In the present example, particles or droplets may not follow gas streamline and may encounter fiber [18][19].

Interception may be beneficial in scenarios where a particle-fiber distance may be equal to or less than the particle or droplet radius. In some scenarios, particles may adhere to an outer layer of a facial garment may be observed [20]. When particles or droplets having a diameter less than 0.1 μm encounter fibers, such particles or droplets may be deflected from their original path and interact with a facial garment due to diffusion or Brownian motion [21]. In some scenarios where a facial garment filter includes electrostatically charged mats, such facial garment filters may attract oppositely charged particles, thereby removing such particles based on electrostatic adsorption. Electrostatic adsorption may be beneficial to filter submicron particles without changing the mask structure and altering pressure drop [22].

In scenarios where an environment may include relatively fine-sized particles, a probability of filtration may be increased by Brownian motion [23][24]. Larger particles, especially those that are within one particle radius, may interact and be intercepted by a filter. Thus, in some scenarios where particles may be in the range of 100 nm to 1 μm, diffusion by Brownian motion and mechanical interception of particles may be a dominant mechanism for particle removal or trapping [23][24]. As droplet or particle size increases (1 μm-10 μm), the particles may be removed based on gravity sedimentation or inertial impaction.

In some scenarios, a charge difference between the filter and the particles may increase filtration efficiency based on electrostatic deposition [25]. Efficiency of a single fiber may be the summation of the above-described filtration efficiencies: E_{F}=E_{D}+E_{R}+E_{I}+E_{B}.

An overall filtration efficiency (FE), which may be defined as the percentage of the particles removed by the filter is related to E_{F}, as shown in Equation (1).

$$FE = 1 - exp ( \frac{- 4 {E}_{F} α L}{π {D}_{f}} ) \qquad ( 1 )$$

where α, L, and D_{f} are the material porosity, filter thickness, and fiber or yarn diameter, respectively [21][26] to [20]. Equation (1) suggests that performance of a filter may be related to fabric material type, knit/weave structure, yarn count, yarn diameter, fiber packing density or thickness in an interrelated manner. In addition to physical properties of a filter itself, the filtration efficiency may be based on external factors or features such as particle size, air flow rate, steady or unsteady pattern of flow, particle charge, respiration frequency, relative humidity, temperature, and loading time [30] to [32]. In some scenarios, efficiency may be lower for uncharged particles, and higher ambient humidity and temperature [24][33][34].

An example of an anti-particulate mask certified by National Institute of Occupational Safety and Health (NIOSH) is the N95 mask. N95 masks may remove the particles having sizes>300 nm and that are not oily, such as those generated by coughing, sneezing, and speaking by 95% under the designated testing conditions [35]. Efficiency of an N95 mask may be lower than 95% in scenarios where droplets or particles are smaller than 300 nm [36].

Surgical face masks are designed for clinical use, but are commonly used (e.g., during a pandemic, to provide a barrier between a user and droplets or particles [33,37]. Surgical masks may include at least three layers including an inner, middle, and outer layer. The inner layer may include moisture absorbing features. The middle layer may include filter media features. The outer layer may include water repellant features [33]. In some examples, surgical masks may be economical and comfortable. However, example surgical masks may have relatively low filtration efficiency for small droplets (<5 μm) [38], unoptimal features for sealing against a user's face, unoptimal fitting performance. In some examples, surgical masks may not be reusable [33,39,40]. Using disposable masks has caused an environmental pollution issue, such as in the ocean environment [41]. Non-woven masks may be constructed of polypropylene micro/nanofibers, which can be shed over time, and may have a lifespan that can be as long as 450 years. More than 1.5 billion masks may have been deposited to the oceans in the year 2020. It may be beneficial to provide facial garments that may be washable, reusable, and constructed at least in part based on textile that may reduce environmental impact.

Even though wearing a face mask may be strongly suggested during the COVID-19 pandemic, studies on the performance of different types of cloth masks are limited and the existing information regarding the efficiency of cloth masks as a function of fabric type and particle size may be insufficient [24][42] to [46].

It may be beneficial to provide a reusable, knitted facial garment that may filter a wide range of particles at a specified pressure drop across the textile based on the ASTM F2100 standard. In some embodiments, a knitted, washable facial garment that may maintain a filtration efficiency of >95% may be beneficial for reducing transmission of respiratory transmitted viruses. In some embodiments, reusable, knitted garments may be constructed of a variety of textile materials and knitting types based on a flatbed knitting machine. In some embodiments, facial garments described herein may be tested based on the ASTM F2299 standard for determining breathability and filtration efficiency at particle sizes related to viruses (e.g., 0.1 μm). Embodiments of facial garments described herein may be based on quantified testing of fabric type and particle size on the performance (e.g., breathability and filtration efficiency).

The goal of this study is to develop a reusable knitted mask that can efficiently filter a wide range of particles at the suggested pressure drop, based on the ASTM F2100 standard. The purpose of innovating a knitted washable mask is to extend the life of the mask while maintaining the filtration efficiency >95% which can be helpful with mitigating the transmission of respiratory viruses such as the coronavirus. Additionally, the study done in this research provides a better insight to systematically investigated the factors affecting mask filtration efficacy. Samples with different material selections and knitting types were prepared whose using a flatbed knitting machine. The performance of knitted samples were tested based on ASTM F2299 to measure the breathability and the filtration efficiency at size ranges relevant to the virus (0.1 μm). In some embodiments, facial garments may be based on the ASTM F2100 standard.

Performance of the facial garment samples may be based on breathability and filtration efficiency characteristics. In some scenarios, test methods may include operations for determining particle filtration efficiency and pressure drop across the textile materials based on ASTM F2299 standards. In some embodiments, for airflow velocity of 0.5 to 25 cm/s, the number of particles in the size range of 0.1 to 5 μm may be measured upstream and downstream of the sample using light scattering particle counting. Filtration efficiency may be determined based on comparing comparing the particle count of the up and downstream. Features of a testing apparatus are provided in the following table (Table 1):

TABLE 1
Testing system characteristics based on ASTM-F2299

| | | Particle | Relative |
|---|---|---|---|
| Air face velocity | Particle size | concentration | humidity |
| 0.5-25 cm/s | 0.1 to 5 μm | 10⁷-10⁸ particles/m³ | 30-50% |

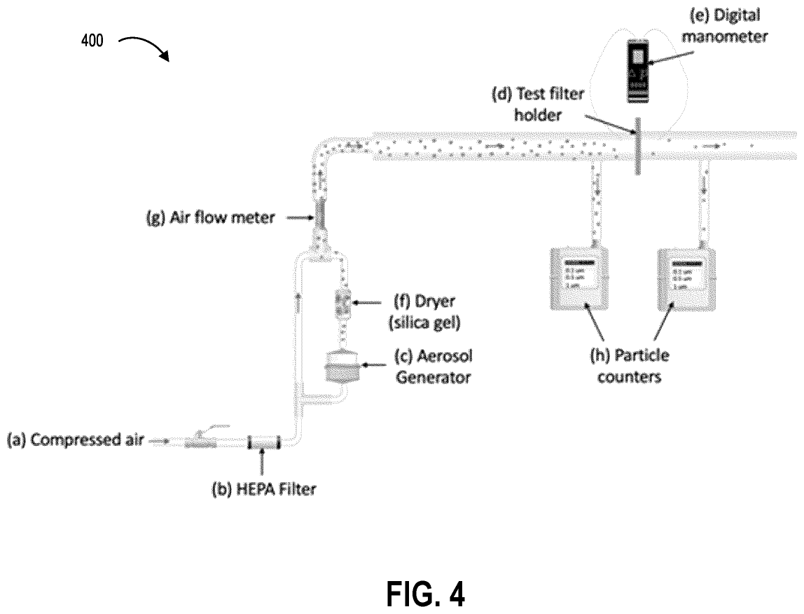

Reference is made to FIG. 4, which illustrates a system 400 configured for testing facial garments based on one or more characteristics, such as breathability, filtration efficiency, or the like, in accordance with embodiments of the present disclosure. The system 400 may include clean/dry compressed air supply, one or more high-efficiency particulate air (HEPA) filters, an aerosol generator, a test filter holder and duct assembly, pressure drop measuring device, dryer (silica gel packets), air flow rate measuring device, and one or more particle counters.

During operation, compressed air may traverse or pass through the HEPA filter to generate a clean air supply. Aerosol particles may be generated based on polystyrene microspheres (polybead, polysciences, Inc.) suspended in deionized distilled water, thereby producing particles with diameter size of 0.1-1 μm. In some above-described scenarios, a main source of airborne transmission of SARS-CoV virus to the respiratory system may be droplet nuclei or aerosol particles below 5 μm [15][47][48]. Some example testing scenarios disclosed herein may be limited to 0.1 to 1 μm particles. Prior to injection, latex aerosol may be mixed and diluted with makeup air, and may be introduced 10 duct diameters upstream of the cloth filter, thereby providing mixing. An optical particle counter (e.g., TSI AEROTRAK portable particle counter-Model 9110) may be configured detect particle size and concentrations.

As the maximum particle concentration that may be measured using AEROTRAK particle counter is 3.5×10⁶ particles/m³, the aerosol concentration introduced to the system may be ˜3.5×10⁶ particles/m³, which may be lower than the value recommended by ASTM-F2299 (10⁷-10⁸ particles/m³). Effective area of the cloth sample during the tests was 19 cm². The measurement of particle size and concentration may be made 2 duct diameters upstream and 3 duct diameters downstream of the sample for 1 minute. The differential pressures may be measured using a digital differential pressure manometer (Extech HD750). The pressure taps may be installed 1 duct diameter upstream and downstream of the cloth mask. Testing experiments for pressure drop and filtration efficiency may be performed at face velocity of 25 cm/s and 7 cm/s, respectively. This flow rate maintains the sampling flow line in the laminar regime (Re<1000), as required by ASTM-F2299. The flow rate may be maintained using an adjustable valve and a volumetric flowmeter (king instrument). The sampling line length may be ˜1 m and the radius of curvature of the sampling line may be larger than 12 cm. Keeping Re<1000 and limit the line length to 1 m may minimize the sample losses due to settling, diffusion and inertia in the line. The measurement of both the breathability and filtration efficiency may be done after 5 minutes equilibrium time and both upstream and downstream may be sampled for 1 minute. Prior to the measurement, the particle counter may be warmed up for 10 to 15 min. Additionally, by running the particle generator with distilled water and comparing the particle counts with that of clean dry air, it may be verified that the aerosol is dried before reaching the sample.

Knowing the particle concentration of upstream Cᵤ and downstream C_{d}, the filtration efficiency may be calculated using Eq. (2).

FE=1−C_{d}/Cᵤ (2)

For respective samples, results for pressure drop and filtration efficiency may be the average of 9 measurements: 3 fresh samples may be tested each for 3 times. Uncertainties in filtration efficiency measurement may be ±3%. Test samples may be mounted based on operations that reduce stretching of the test samples.

Although it may be suggested by the ASTM F2299 standard to pass particles through a charge neutralizer, in scenarios where generated particles that may be possibly highly charged may not be neutralized after emission. In some scenarios, particles may become neutral soon after being generated. However, depending on the number of particles that remain charged, filtration efficiency may vary. In some embodiments, the system 400 may conduct measurement operations in a leak-free environment. It should be noted that improper mask fit results in air leak which may reduce the mask effectiveness.

In some scenarios, a weft flatbed knitting machine (Stoll, Reutlingen, Germany) with two sets of needles may be employed, where samples with a varied combination of yarns and with a wide variety of stitch constructions may be knitted. Variation in fiber properties and fabric structures may be combined to achieve the desired depth and surface filtrations for particles impaction, retention, adsorption, and diffusion in the 3-layer structure of the masks.

In some embodiments, multi-layered structures may provide increased filtration efficiency. An initial study on the filtration of cloth masks illustrated that the filtration efficiency may improve by increasing the number of mask layers [44][50].

In some embodiments, hybrid multi-layer structures may improve mask performance based on different removal mechanisms. To illustrate, performance testing of 20 samples knitted using nylon, cotton, Lycra™, and polyester yarns were tested.

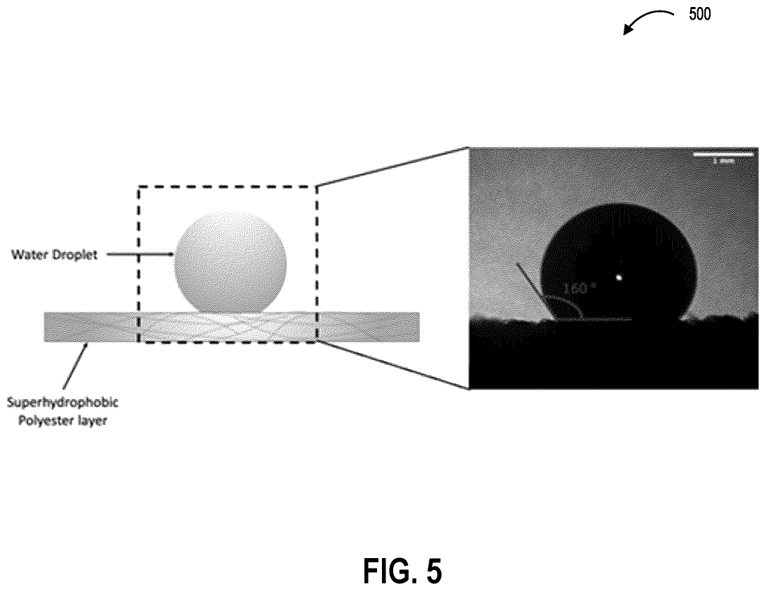

In some embodiments, an outer layer may include a super-hydrophobic Polyester yarn as a first layer barrier. The first layer may be configured as a surface filtration barrier that may repel aerosol particles or blood from adhering to the outer surface, similar to commonly used polypropylene non-wovens. A contact angle of a particle or droplet at an outer layer may be measured to be 160°, confirming the super-hydrophobicity of the layer. For example, FIG. 5 illustrates a water droplet 500 at a textile surface, in accordance with an embodiment of the present disclosure. A contact angle at the superhydrophobic layer may be shown based on a high resolution image.

In some embodiments, an interconnecting or middle layer may be spacer yarn constructed based on nylon wrapped Lycra™ which may be used for plating. The interconnecting layer may bond an inner and an outer of a facial garment. The interconnecting or middle layer may be configured to provide a 1-way wicking feature, which allows wicking only in one direction so that inner moisture can wick out and not the other way. In some embodiments, the inner layer may be a comfortable cotton-nylon combination.

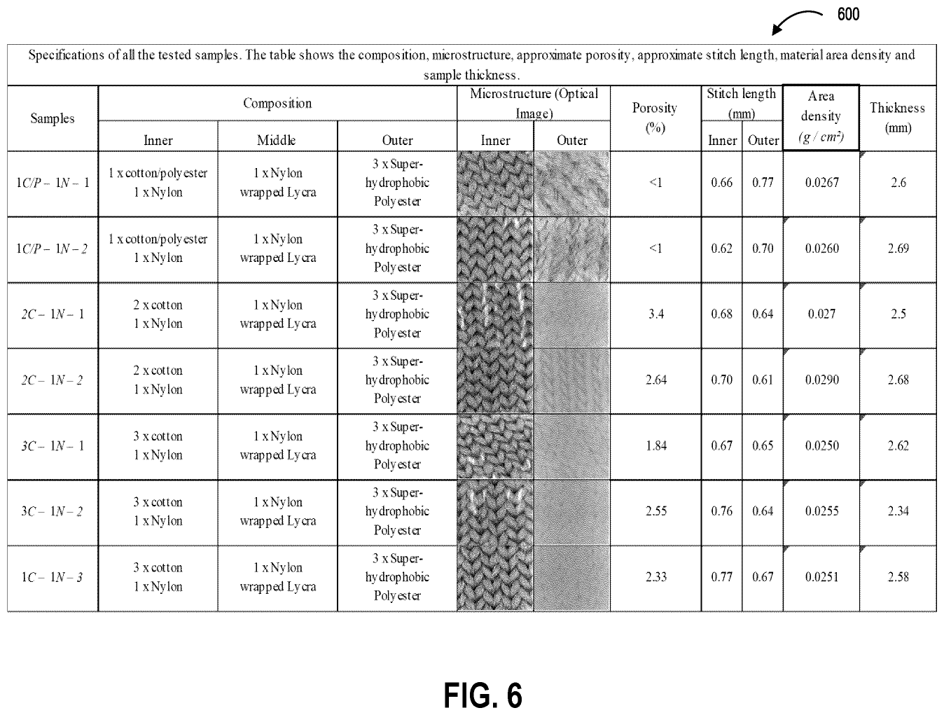

As non-limiting examples, numerous samples having varying composition and varying textile layer features are shown in FIGS. 6 to 8, in accordance with embodiments of the present disclosure. FIGS. 6 to 8 provide tables (600, 700, 800) of specifications of testing samples, showing composition, microstructure, approximate porosity, approximate stitch length, material area density and sample thickness.

In some embodiments of the sample textiles, material of the outer and interconnecting/middle layer may be similar and material of an inner layer may include different composition and stitch lengths. Area density (g/cm²) may be calculated by weighting 10 mm samples and dividing their weight by the area. The sample thickness may be measured using a caliber. The results may be the average of 5 measurements.

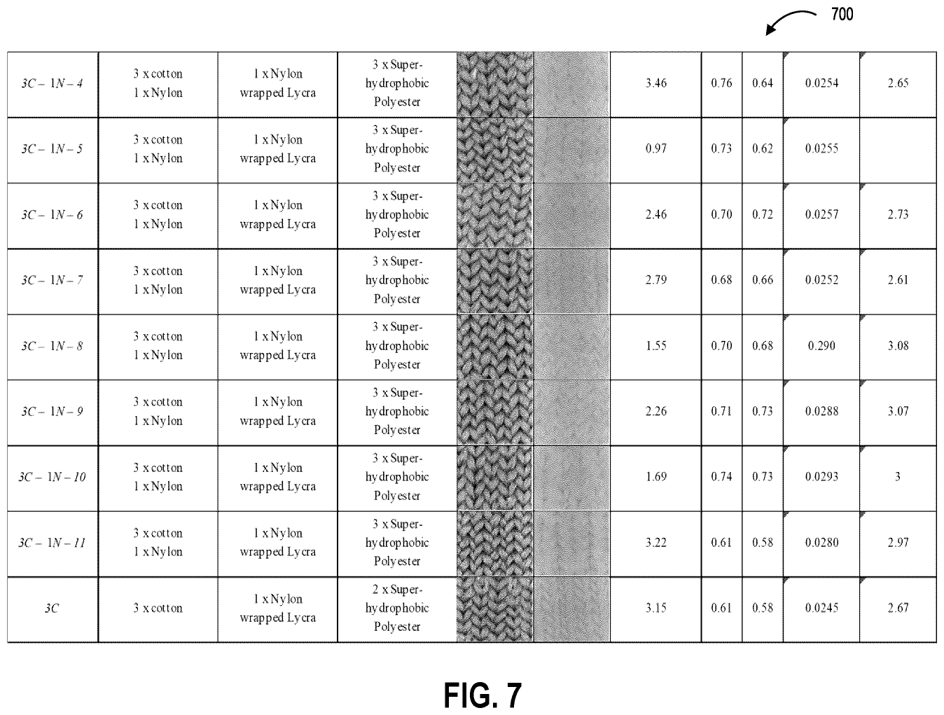

In some experiments, it may be beneficial to observe effect of laundering knitted textile garments on performance factors such as filtration efficiency and pressure drop (e.g., related to breathability). To illustrate, experiments were conducted on “sample 3C” having features identified in FIG. 7, and sample 3C was tested for filtration efficiency and breathability after 0, 10, 20, 30, 40, and 50 wash cycles. Each wash cycle was configured at 60 degrees Celsius for 35 minutes, and tumble dry cycles (60 degrees Celsius for 40 minutes). That is, sample 3C was tested for filtration efficiency and breathability for 0, 10, 20, 30, 40, and 50 dry cycles. Each dry cycle was configured at 60 degrees Celsius for 40 minutes. For the above-described experiments, observations were made to identify the number of wash cycles before filtration efficiency was reduced. Changes in stitch length and yarn liner density associated with the fabrics were also observed.

In some scenarios, material micro-imaging may include operations using an USB digital microscope (e.g., 20×-800×, 8 LED light USB mini digital microscope) having one or more light emitting diodes and a color CMOS sensor. Captured images associated with respective testing samples may be found in FIGS. 6 to 8. For example images disclosed herein, the imaging resolution was 6.7 μm. Operations for determining stitch length of knitted material was based on optical images and was averaged over at least 20 measurements.

Scanning electron microscopy (JEOL, JSM 1000) may be used to evaluate the morphological characteristics of the cotton and nylon fibers. A yarn sample with a length of 2 cm and part of the knitted fabric may be used for imaging.

In some scenarios, testing operations included determining the porosity of the material using a digital microscope. When determining porosity of samples, a backlight based on a flashlight was used. Transmitted light was captured and results were averaged over at least 10 porosity measurements. Compared to several previous works that estimated the porosity by dividing the number of yarns per unit length to the square root of the yarn count, operations based on direct imaging methods for finding the porosity may be beneficial at least because such operations also take into account the porosity of fibers.

In some scenarios, testing operations included measuring contact angle at an outer layer based on a high-resolution camera with 42 fps, 6 Megapixel resolution and effective pixel size of 2.4 μm. A high resolution image (see e.g., FIG. 5) was examined to determine a contact angle between a particle or droplet at the surface of the textile sample.

In some scenarios, it may be beneficial to provide facial garments configured to filter or to act as a barrier to a wide range of particle sizes. As will be described herein, in some embodiments, facial garments may be configured to include layered textile structures including fibers having a range of fiber diameters.

In some embodiments, facial garments may be configured to reduce pressure drop across the combined textile layers. In some embodiments, facial garments may include knitting structure features for interconnecting textile layers to increase particle filtration efficiency. For example, knitting structure features may include loop density and stitch length, yarn count, or the fabric's fiber composition on the filtration efficiency [23][24][51]-[54]. The present disclosure provides embodiments of facial garments having various parameters that may influence facial garment effectiveness in view of performance metrics such as filtration efficiency or textile breathability.

In some embodiments, facial garments may include multi-layer knitted fabrics of natural and synthetic fibers, such that the facial garment may be a reusable structure for filtering one or more particle sizes.

### Breathability

In some embodiments, facial garment performance may be based on quantified pressure drop across the facial garment textile. Pressure drop may be correlated with breathability of the facial garment. It may be beneficial to correlate facial garment performance in combination with variation in textile features, including yarn count T, fabric porosity a, number of yarn ends, or textile thickness. In some scenarios, pressure drop may be determined based on dividing a measured pressure drop by the sample area (19 cm²). The quantified pressure drop value may be provided as mmH₂O/cm².

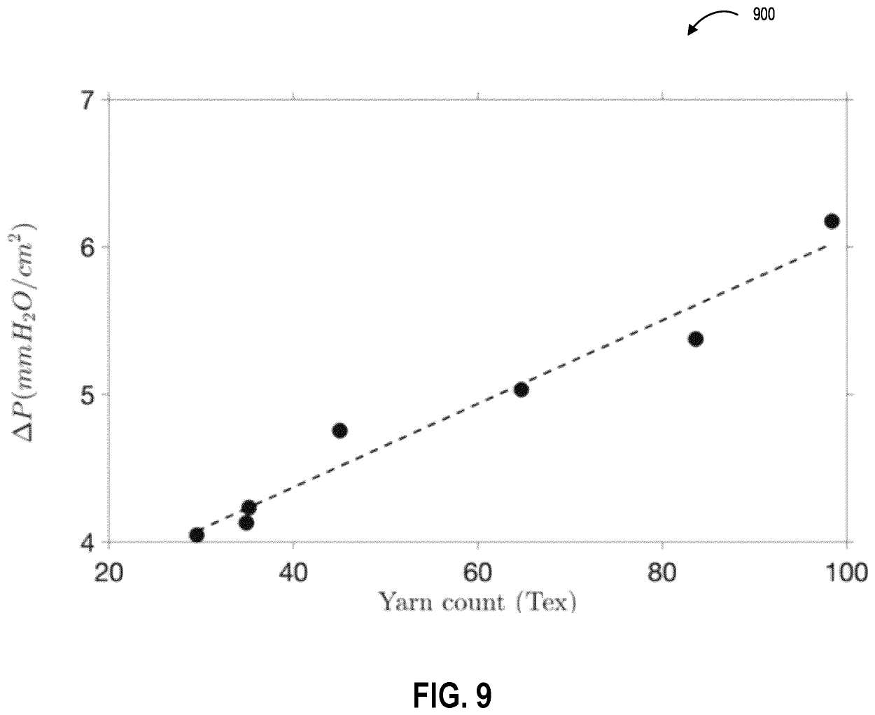

For a given material and outer and middle layer knitting structure, pressure drop for different inner layer yarn counts (30-100 Tex) may be studied at air face velocity 25 cm/s. As an example illustrated in the chart 900 of FIG. 9, pressure drop may be linearly related to the yarn count and may increase from 3.7 to 6.2 mmH₂O/cm² by increasing the yarn count from 30 to 100 Tex.

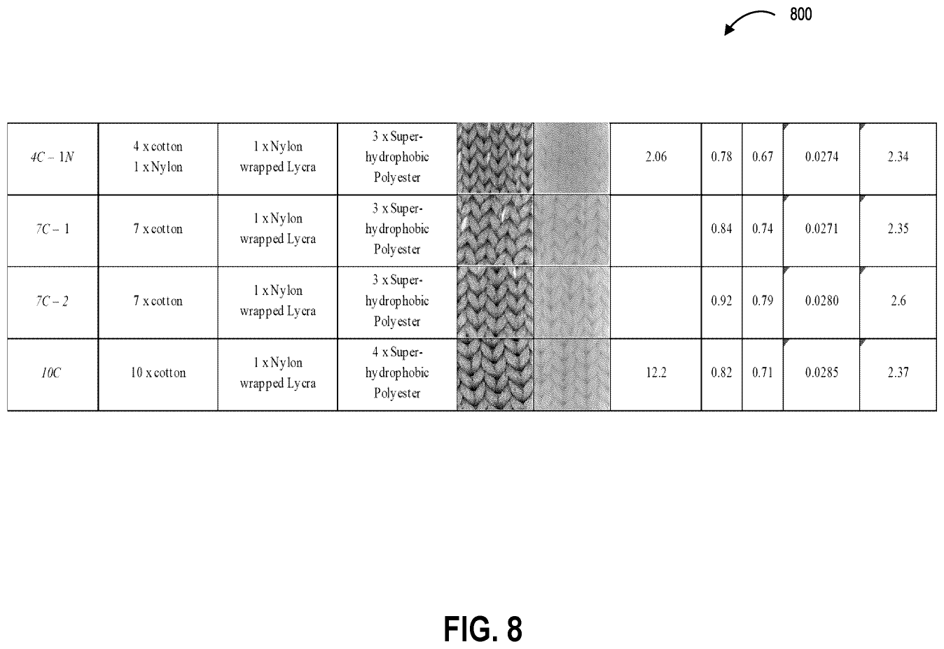

For illustration, findings based on test sample configurations outlined in FIGS. 6 to 8 will be disclosed. Test sample 10C (see FIG. 8) with yarn count of 100 Tex appeared to have the highest yarn count and the second highest pressure drop, 6.2 mmH₂O/cm², which is much higher than the limit suggested by ASTM F2100 for level 1 masks (5 mmH₂O/cm²).

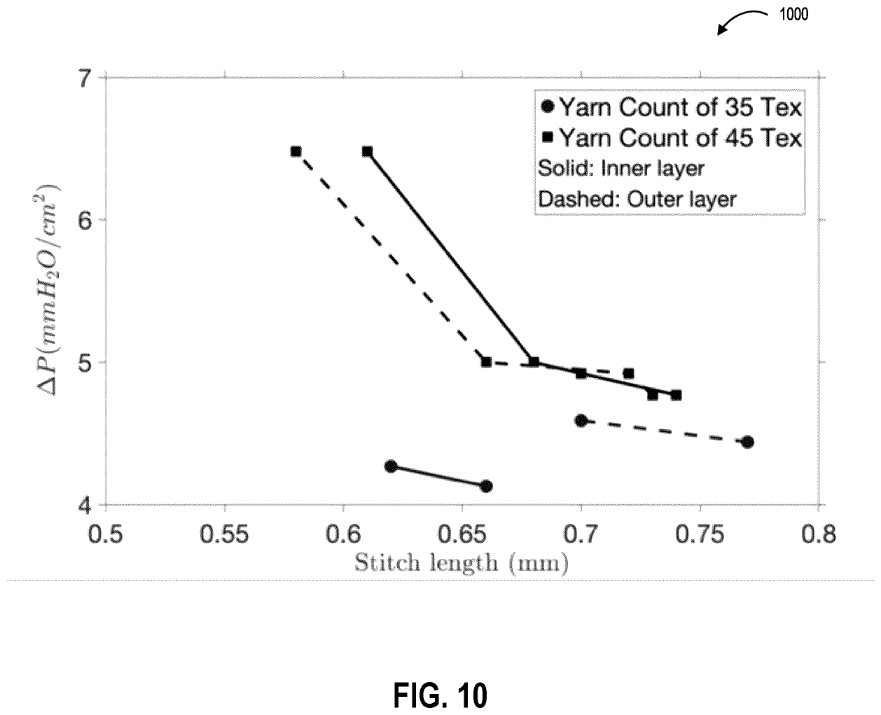

At air face velocity of 25 cm/s, the effect of inner and outer stitch length (0.6-1 mm), defined as the length of the yarn in a knitted loop, on the pressure drop was observed. FIG. 10 illustrates a chart 1000 showing the effect of stitch length on pressure drop across a textile sample, in accordance with embodiments of the present disclosure. Test results illustrate that pressure drop may increase when stitch length decreases: shorter stitch lengths, meaning tighter knitted masks, lead to higher pressure drop.

For illustration, with a yarn count of 35 Tex, the measured pressure drop may be 4.44 mmH₂O/cm² for the loosest samples (inner and outer stitch length of 0.74 mm), and 6.03 mm H₂O/cm² for more tightly knitted samples (inner stitch length of 0.61 mm and outer stitch length of 0.58 mm).

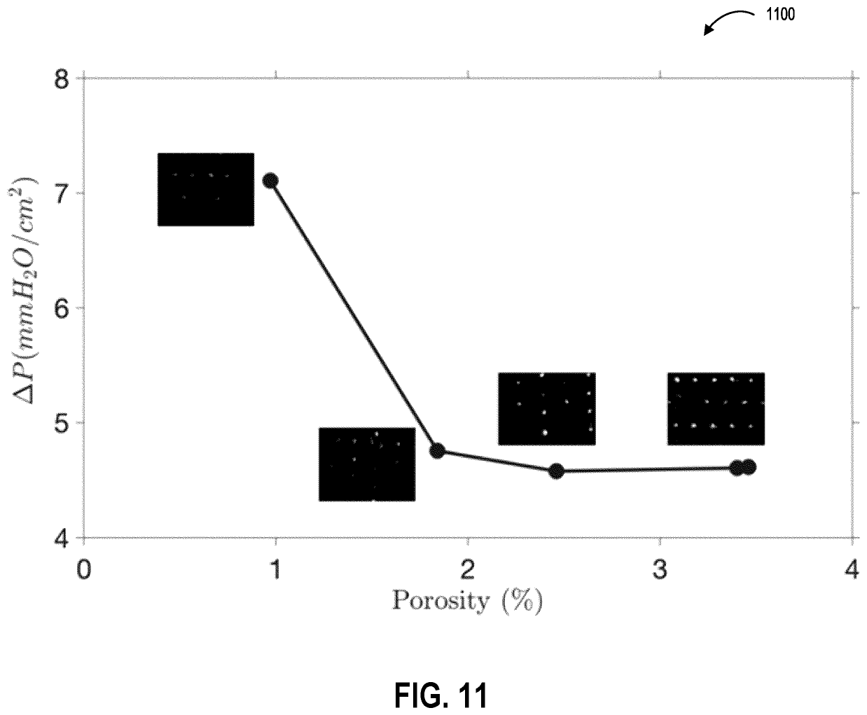

FIG. 11 illustrates a chart 1100 showing the relation between pressure drop and porosity of textile samples. To determine porosity, a sample may be backlit based on a flashlight. The light that passes through pores may be captured using a USB digital microscope, and the data may be used to determine porosity. In some scenarios, pressure drop may be greater for samples with lower porosities: 7.11 mmmH₂O/cm² for samples with porosity of 0.97% and 4.61 mmH₂O/cm² for samples with porosity of 3.4%. In some scenarios, air may pass through a textile sample more readily when the textile sample is more porous.

In scenarios where a textile sample includes smaller pores, a pressure drop across a textile sample may be greater, but may experience a reduced pressure drop over time in view of high-velocity air widening pores of the textile sample.

FIG. 11 also shows that the effect of porosity on pressure drop across a textile sample is more prominent at lower porosity values, with pressure drop being less significant as porosity of the textile sample increases.

In some embodiments, cotton may be configured for use with facial garments. In some examples, altering the number of cotton ends associated with an inner layer of a facial garment may alter the quantitative performance of the facial garment. In some embodiments, pressure drop across the facial garment may increase when increasing the number of cotton yarn ends: Δp is 4.23 mmH₂O/cm² and 6.24 mmH₂O/cm² for samples with 2 and 10 ends of cotton yarn, respectively. In some scenarios, for sample stitch length and porosity, facial garment samples with 4 or more cotton ends may exceed the pressure drop recommended by ASTM F2100.

Comparing samples with yarn count of 45.02 Tex shows that the pressure drop may not depend on the sample thickness; and features such as sample stitch length and porosity are better representatives for the sample pressure drop.

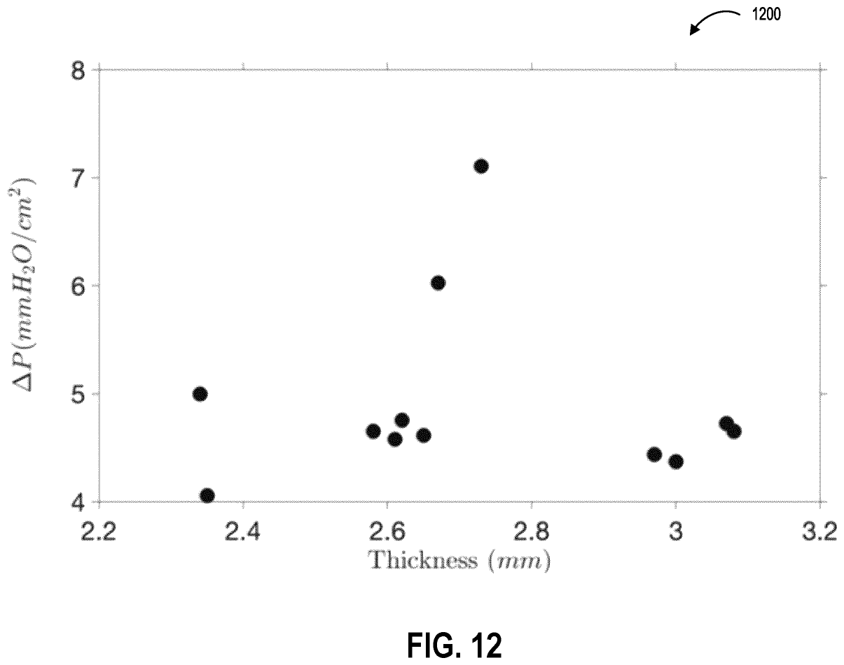

FIG. 12 illustrates a chart 1200 showing pressure drop as a function of sample thickness, in accordance with embodiments of the present disclosure.

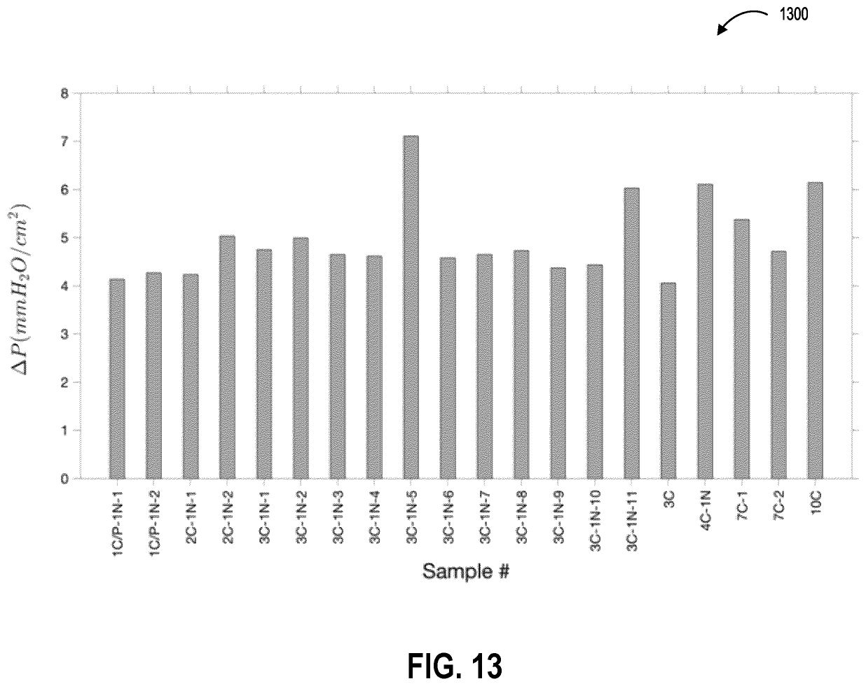

In some experiments, a relatively small pressure drop, 4.05 mmH₂O/cm², was observed for sample 3C (inner layer of 3× cotton) (see FIG. 7). As shown in a chart 1300 of FIG. 13, textile sample 16 has a low yarn count with a value of 29.02 Tex. In comparison, a large pressure drop was observed for sample 3C-1N-5 (inner layer of 3× cotton-1× Nylon) (FIG. 7), having the lowest porosity, 0.97% (see FIG. 13).

### Filtration Efficiency

In some experiments of the present disclosure, filtration efficiency for 20 mask samples (natural, synthetic, natural/synthetic blend) was observed based on facial garment textiles interacting with particle sizes ranging from ˜100 nm to ˜1 μm. Observations show that the filtration efficiency may be related to the fiber type, fabric mass, stitch length and knitting structure in a relatively complex manner. Further, facial garment filtration efficiency may be based on a function of particle diameter. In one or more experiments, facial garment samples were characterized based on their material composition, yarn count, stitch length, porosity, thickness and material area density. The facial garment samples were observed to identify effects of textile features/parameters and particle diameter on overall facial garment filtration efficiency.

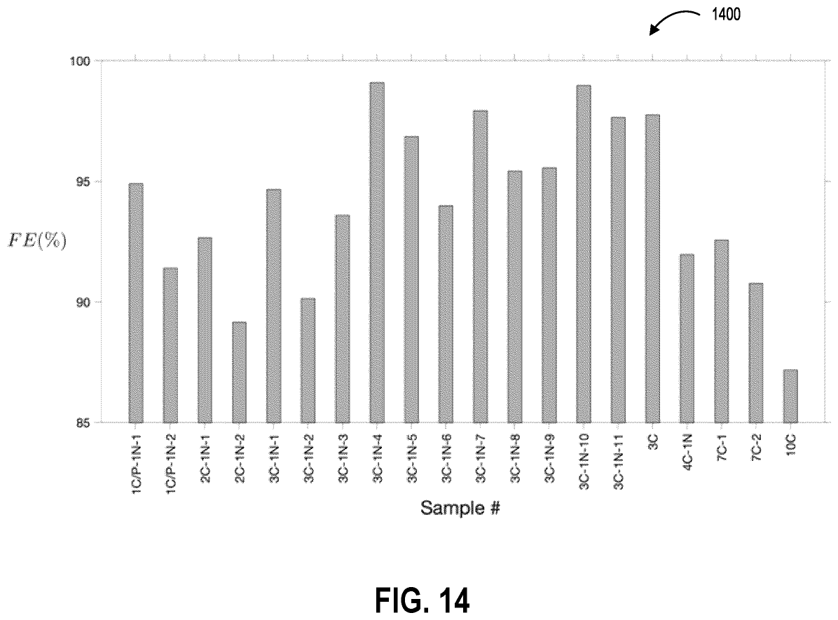

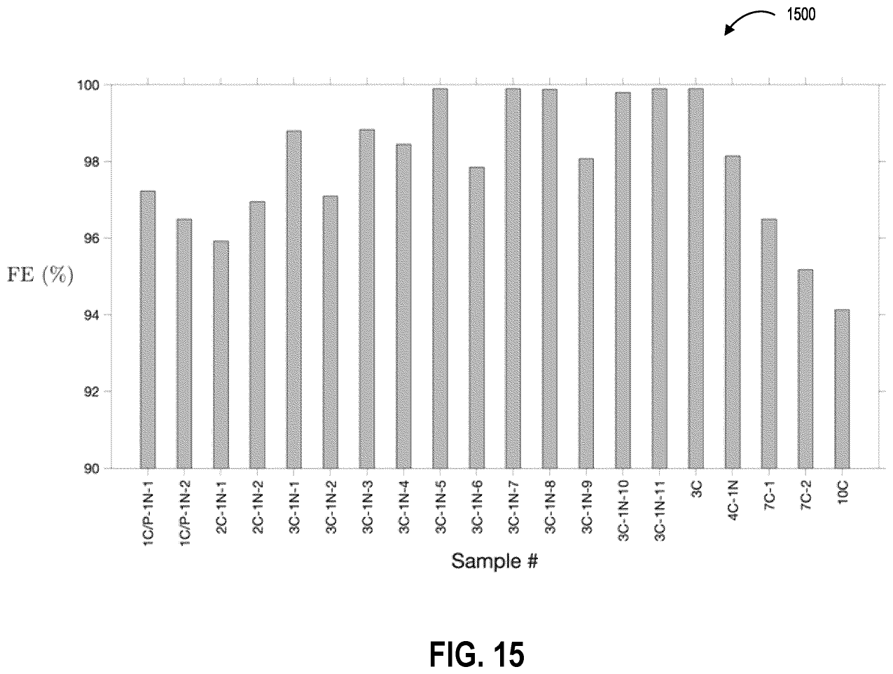

FIGS. 14 and 15 illustrate observation results of the various samples and the respective filtration efficiency, in accordance with embodiments of the present disclosure. In some embodiments, facial garments may include one or more textile layers directed to filtering different particle sizes (e.g., particle sizes below 100 nm or particle sizes above 1 um, among examples). Accordingly, observation results were separately obtained for smaller particle sizes (100-250 nm) and larger particle sizes (250 nm-1 μm).

In the observed facial garment samples, the respective samples exhibited high efficiency when blocking or removing large particles: filtration efficiency is larger than 97.3% and 99.9% for particle size of ˜500 nm and ˜1 μm, respectively. In comparison, the observed facial garment samples exhibited lower efficiency when blocking or removing smaller particles: e.g., for particle sizes of 100 nm, most facial garment samples exhibited a filtration efficiency of ˜89%, with a select few facial garment samples exhibiting a filtration efficiency higher than 95%. The observations suggest that mask filtration mechanisms such as interception and inertial impaction may have a pronounced role for filtering or blocking ˜500 nm and ˜1 μm particles, respectively, having desirable performance for all the samples leading to a high efficiency for the removal of 500 nm-1 μm particles. In contrast, facial garment samples exhibit different filtration efficiency associated with relatively smaller sized particles (<250 nm).

For smaller particles (e.g., having particle size in the range of 100-250 nm), sample 3C-1N-4 (with inner layer composition of 3× cotton and 1× Nylon-porosity of 3.46%), sample 3C-1N-10 (with inner layer composition of 3× cotton and 1× Nylon-porosity of 3% and porosity of 1.69%) and sample 3C (with inner layer composition of 3× cotton and 1× Nylon-porosity of 3.15%) exhibited the highest filtration efficiency with values of 99.1%, 98.9, and 97.8%, respectively. Based on the above-described experiments, a number of cotton ends that maximizes filtration efficiency of 100-250 nm particles may be 3 ends. The above-described samples exhibit the smallest standard deviation for the filtration efficiency across the entire particle size range: 1.69%; 0.92% and 0.81% for sample 3C-1N-4, 3C-1N-10, and 3C, respectively. Based on the above-described observations, filtration efficiency for these samples may not be strongly correlated with particle size, thereby making these facial garment sample configurations desirable for mask fabrication. These filtration efficiency observations may be similar to the filtration efficiency of N95 masks that was reported to be invariant with particle size [23].

For the respective facial garment samples, higher filtration efficiency was observed for larger particles. The largest filtration efficiency was observed with sample 3C-1N-7 (with inner layer composition of 3× cotton and 1-Nylon-porosity of 2.79%) and 3C-1N-11 (with inner layer composition of 3× cotton and 1× Nylon-porosity of 3.22) with an FE of 99.9% for 250 nm-1 μm particles. These facial garment samples include 3× cotton and 1× Nylon in their inner layer and have the lowest inner and outer layer stitch lengths: 0.68 mm and 0.66 mm for inner and outer layer of sample 3C-1N-7, respectively, and 0.61 mm and 0.58 mm for inner and outer layer of sample 3C-1N-11.

In some scenarios, the effect of stitch length on particle removal becomes more significant for larger particles. One of the mechanisms of filtering the particles around 1 μm may be interception, whereby effectiveness may depend directly on a distance between two fibers. Compared to open material structures, for samples with lower stitch lengths, the fabric may be tighter, i.e., the opening between the fibers is smaller and particles may be more easily trapped therein. In loose materials, however, the particles can more easily slip between the openings of the fabric and pass through. Sample 3C-1N-7 and 3C-1N-11 are tight enough to effectively remove particles having a particle size of approximately 1 μm.

In some embodiments, filtration theory suggests that the most penetrating particle size (MPPS) at minimum filtration efficiency (FEₘᵢₙ) may be between 50 nm and 500 nm [18]. For a particle size range from 20 nm to 10 microns, the filtration efficiency may be generally larger at the two ends of the range: diffusion and electrostatic attraction may be more efficient for smaller particles, while with interception, impaction and gravity settling predominates the removal of larger particles. Accordingly, the minimum filtration may be shown in the range of 50-500 nm.

FIG. 14 illustrates a chart 1400 showing filtration efficiency for particles in the 100 to 250 nm range, in accordance with embodiments of the present disclosure.

FIG. 15 illustrates a chart 1500 showing filtration efficiency for particles in the 250 nm to 1 μm range, in accordance with embodiments of the present disclosure.

### Filter Quality Factor

In some scenarios, facial garment performance may be evaluated based on filtration efficiency. In some scenarios, facial garment performance may also be evaluated based on quality factor. For example, it may be beneficial to configure a facial garment having a high filtration efficiency while having relatively smaller pressure drops across the facial garment textile, thereby contributing to textile breathability. In some embodiments, performance of a facial garment textile may be based determining a quality factor (QF). In some scenarios, QF may be determined based on equation 3.

QF=(−ln(1−FEₘᵢₙ/100))/Δ (3)

where Δp is the pressure drop in kPa [18][51][65]-[67]. Quality factor may be higher for samples with higher filtration efficiencies and lower pressure drops.

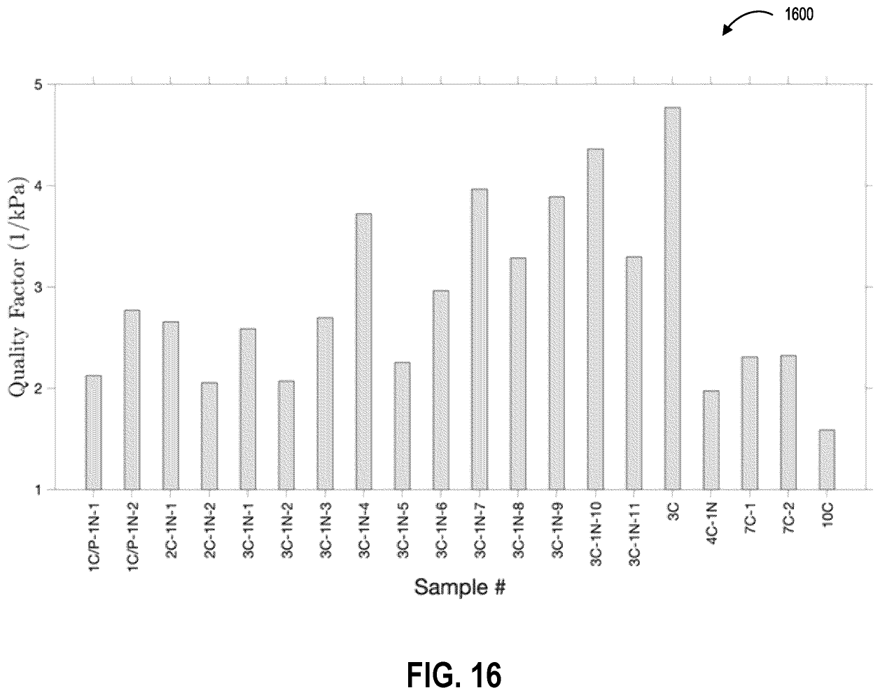

Reference is made to FIG. 16, which illustrates QF values for a plurality of facial garment textile samples, in accordance with embodiments of the present disclosure. As shown in the chart 1600 of FIG. 16, sample 3C exhibits the largest quality factor value. Sample 16 is configured to have an inner layer composition of 3× cotton, and was observed to have a quality factor value of 4.77 kPa⁻¹. In some embodiments, facial garment samples having the most desirable performance may have a combination of both high filtration efficiency and breathability. Although there are samples with higher filtration efficiencies (sample 3C-1N-4 and 3C-1N-10 with filtration efficiency of 99.1% and 98.9%, respectively, for particles having size of 100 to 250 nm, compared to sample 3C with filtration efficiency of 97.8%) or comparable filtration efficiencies (sample 3C-1N-5 with filtration efficiency of 97.9% and sample 3C-1N-11 with filtration efficiency of 97.7%), such samples are shown to have lower quality factors as compared to sample 3C due to a lower FEₘᵢₙ or higher pressure drop across the facial garment textiles. Having a higher pressure drop across the facial garment textile may contribute to making it more challenging for a user to breath when the facial garment is worn.

As an example, the quality factor of sample 3C-1N-5 was determined to be 2.52 kpa⁻¹. 1/kPa. Sample 3C-1N-5 was observed to have a minimum filtration efficiency of 95.9% and pressure drop of 7.11 mmH₂O/cm². In some scenarios, a pressure drop value of 7.11 mmH₂O/cm² is relatively high and may exceed the ASTM F2100 Level 1 breathability limit. Nevertheless, samples with lower filtration efficiencies such as sample 3C-1N-6, with minimum filtration efficiency of 93.3% and pressure drop of 4.58 mmH₂O/cm², had a higher quality factor of 2.96 kPa⁻¹.

In some embodiments, quality factor metrics may be calculated based on a number of cotton ends. For example, increasing the number of cotton ends from 2 to 3 leads to an increase in both FE and Δp resulting in a QF that may only be slightly better for samples with 3 cotton ends: 2.35 kpa⁻¹ for samples with 2 cotton ends and 2.94 kpa⁻¹ for samples with 3 cotton ends. Accordingly, adding more cotton ends may result in a higher pressure drop without any improved effect on the filtration efficiency, and the quality factor decreases from 2.94 kpa⁻¹ to 1.6 kpa⁻¹ by changing the cotton ends from 3 to 10.

Based on a plurality of tests, sample 3C with pressure drop of 4.05 mmH 20/cm 2, filtration efficiency of 97.8%, and quality factor of 4.77 kPa⁻² showed the most optimal performance among the plurality of test samples. The percentage of the total fiber mass for sample 3C is approximately: 41% super-hydrophobic polyester, 26% cotton, 24% Nylon, and 9% Lycra. In the present disclosure, the effect of repeated washing on the behaviour of sample 3C will be described.

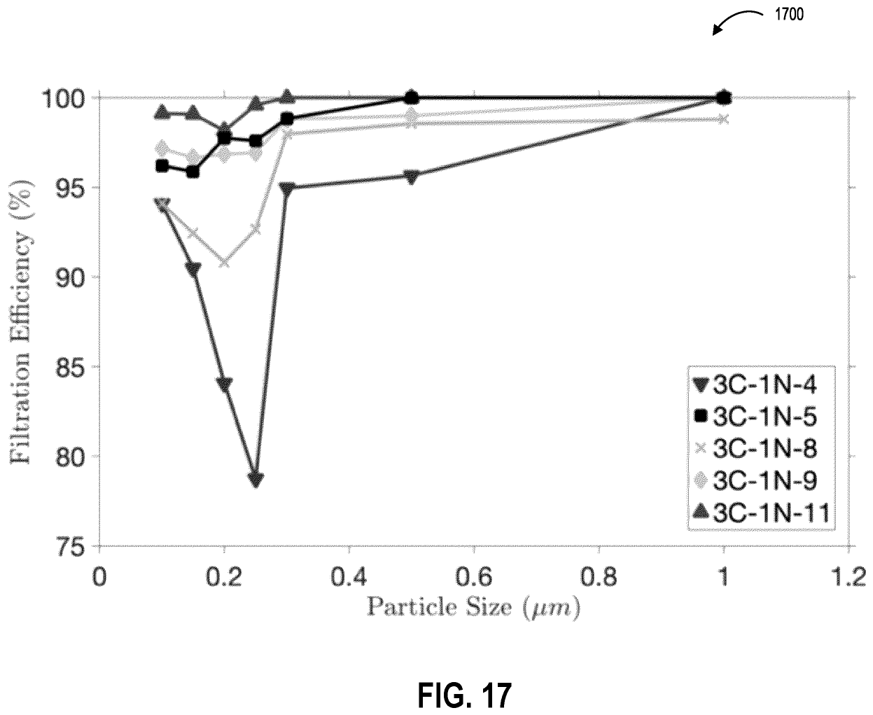

FIG. 17 illustrates a chart 1700 showing filtration efficiency as a function of particle size, in accordance with embodiments of the present disclosure. For example, for facial garment textile samples, with particle sizes in the range of 100 nm-1 μm, filtration efficiency may be greater at the upper and lower ends of the particle size range, and MPPS may between 100-500 nm.

In some scenarios, particle size diameter associated minimum filtration efficiency (MPPS) may be determined based on the efficiency of different removal mechanisms. Given a similar yarn count and constant air flow rate, for increased porosity, filtration mechanism of interception may be less effective. By maintaining a constant the yarn count, stitch length, and the air flow rate, MPPS may shift toward larger particles for samples with higher porosities: MPPS may be 150 μm, 200 μm, and 250 μm for samples with porosities of 1.84%, 2.64% and 3.15%, respectively.

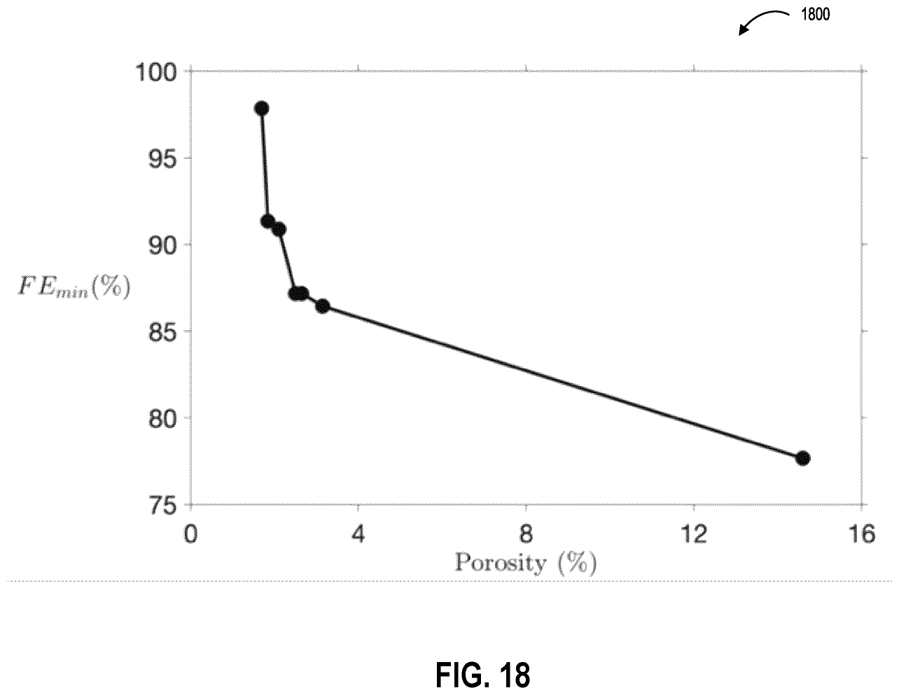

FIG. 18 illustrates a chart 1800 showing an effect of porosity on minimum filtration efficiency. In FIG. 18, by comparing the same yarn count and stitch length, the value of FEₘᵢₙ may decrease by increasing the porosity, which may be due to a larger number of particles passing through the openings of the material.

### Dependence of Filtration Efficiency on the Number of Cotton Ends

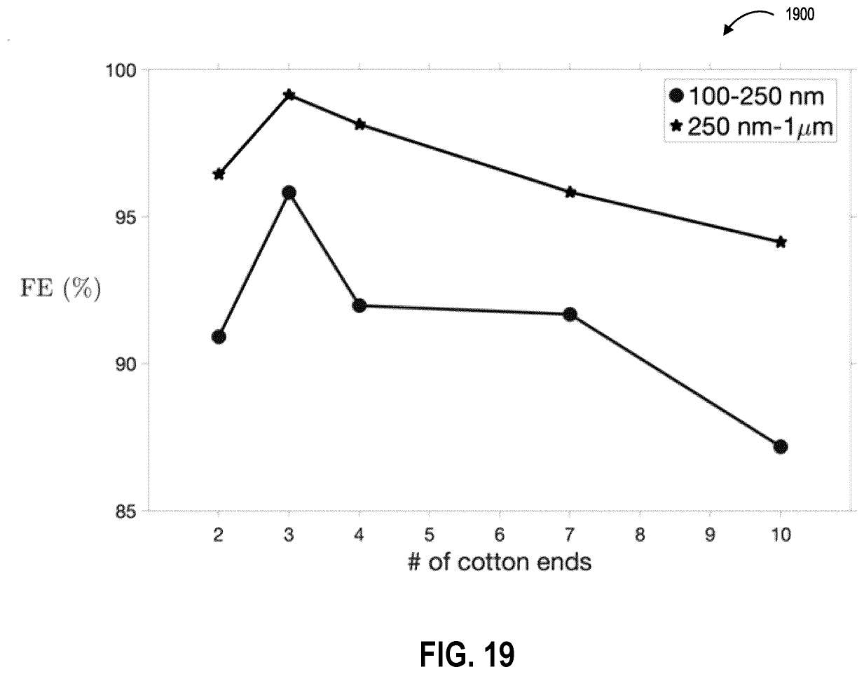

In some scenarios, to identify a relationship between filtration efficiency and number of cotton ends, experiments may be conducted with facial garment samples having 2 to 10 cotton ends. FIG. 19 illustrates a chart 1900 showing results of filtration efficiency across a range of number of cotton ends. In these experiments, facial garment samples included similar middle and outer layer textiles with close stitch lengths. The facia garment samples differed with respect to the number of cotton ends used in their inner layer. The facial garment samples exhibited an efficiency exceeding 89% in the <250 nm range and >97.3% in the range of 250 nm-1 μm.

In comparison to observations of above-described experiments, increasing the number of cotton ends from 2 to 3 increases the removal efficiency of 100-250 nm and 250 nm-1 μm particles from 90% to 96% and from 96.4% to 99.1%, respectively. Increasing the number of cotton ends greater than 3, however, may not exhibit any observable improvement in filtration efficiency. In some scenarios, increasing the number of cotton ends may lower filtration efficiency. For example, increasing the number of cotton ends from 3 to 10 decreases the filtration from 96% to 87.2% for 250 nm-1 μm particles and from 99.1% to 94.1% for 500 nm-1 μm particles. The above described observations suggest that there may be an optimum number of cotton ends that maximizes the filtration efficiency. That is, in some embodiments, configuring a facial garment to have three cotton ends may provide an optimal filtration efficiency.

In some embodiments, facial garment feature associated with web structure may improve filtration efficiency. In some embodiments, the web structure may be formed by protruding hairs and neps. A Nep may be an entangled fiber that forms a fiber-web due to the cotton fibers being extended and protruded from the main surface. For example, knitting the facial garment samples based on yarns with a greater number of protruding hairs and neps may provide formation of a web structure that may enhance the particle removal by diffusion and interception.

In some embodiments, configuring facial garments having up to 3 cotton ends may provide more disordered web structure. In some scenarios, a higher number of cotton ends may weaken the web structure of the sample and lead to lower values for the filtration efficiency. Thus, sample 10C (inner layer composition of 10× cotton) having an inner layer with the largest yarn count and largest number of cotton ends may exhibit the lowest filtration efficiency amongst all the tested samples: 87.2% for 100-250 nm particles and 94.1% for 250 nm-1 μm particles.

### Effect of Adding Synthetic Fiber on the Filtration Efficiency

In some scenarios, filtration efficiency of a textile may be dependent on the fiber chemistry, fiber source, yarn widths and fabric construction [56][57]. The effectiveness of filtration may be altered by changing the fiber diameter, range of diameter, fiber shape and fiber composition [57][58]. To illustrate the effect of synthetic fiber on the filtration efficiency, samples 1C/P-1N-1 (inner layer composition of 1× cotton/polyester-1× Nylon) and 1C/P-1N-2 (inner layer composition of 1× cotton/polyester-1× Nylon) may be compared with sample 2C-1N-1 (inner layer composition of 2× cotton-1× Nylon). Compared to sample 2C-1N-1 which may have a natural fiber (cotton), samples 1C/P-1N-1 and 1C/P-1N-2 with natural/synthetic blend yarn (cotton/polyester) may have a higher filtration efficiency for both small and large particles.

An improved filtration efficiency, especially for small particles may be explained by more efficient electrostatic particle removal for samples with synthetic fibers [23][24][55][56]. Fabrics may retain electric charge in their pores, acting like a capacitor [59]. The ability of charge collecting of a fabric may depend on its fiber material, knitting type, and its tightness [60]. Higher charge difference between a fiber and a particle may lead to an enhanced electrostatic deposition [23][55]. Electrostatic interactions may be more noticeable in synthetic fabrics such as Polyester [23][55]. Compared to natural fibers like cotton, synthetic fibers may have lower water adsorption properties resulting in a higher static charge collection [61]. Accordingly, higher filtration efficiency for sample 1C/P-1N-1 and 1C/P-1N-2 may be shown, where these samples may have their inner layers knitted with cotton/polyester rather than cotton.

In some scenarios, however, facial garments configured with synthetic fibers may not always provide for enhanced filtration efficiency. For example, when comparing sample 3C-1N-11 (inner layer composition of 3× cotton-1× Nylon; Outer layer composition of 3× Super-hydrophobic Polyester) and 3C (inner layer composition of 3× cotton; outer layer composition of 2× Super-hydrophobic Polyester), the samples have substantially similar filtration efficiency associated with 100-250 nm particles: 97.7% for sample 3C-1N-11 and 97.8% for sample 3C. As the filtration efficiency, especially for fine particles, may be a function of charge state and charge distribution of the particles, in some scenarios, electrostatically charged particles may be neutralized or less electrostatically charged once the particles interact with the facial garment textile. Accordingly, electrostatic deposition may not always result in increased filtration efficiency.

For particles in the range of 500 nm-1 μm, configuring a facial garment to include a synthetic fiber may provide a decrease in the filtration efficiency: 99.9% for sample 3C and 97.5% for sample 3C-1N-11. For large particles, mechanical filtration is mainly responsible for particle removal and its effectiveness depends on the fiber diameter and fiber width variability.

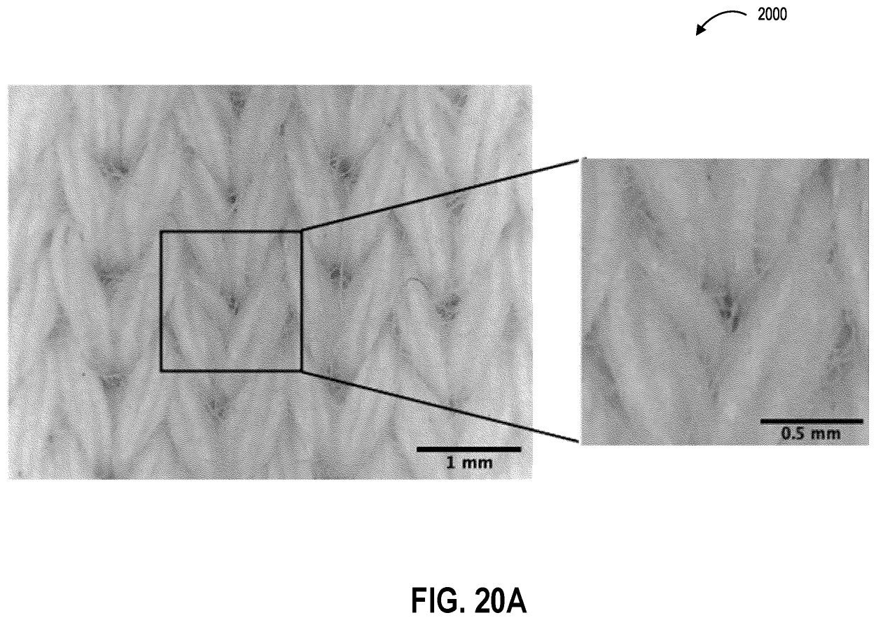

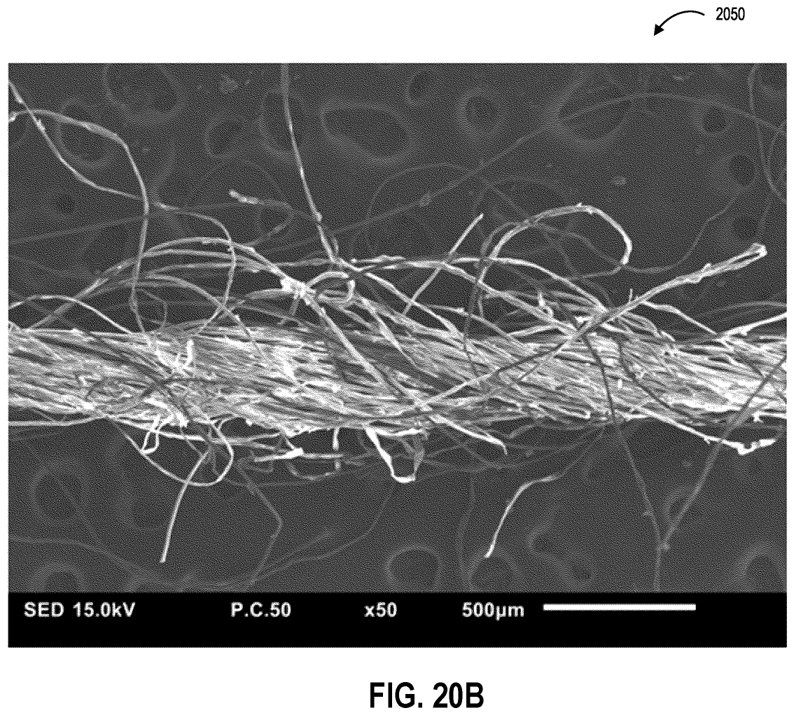

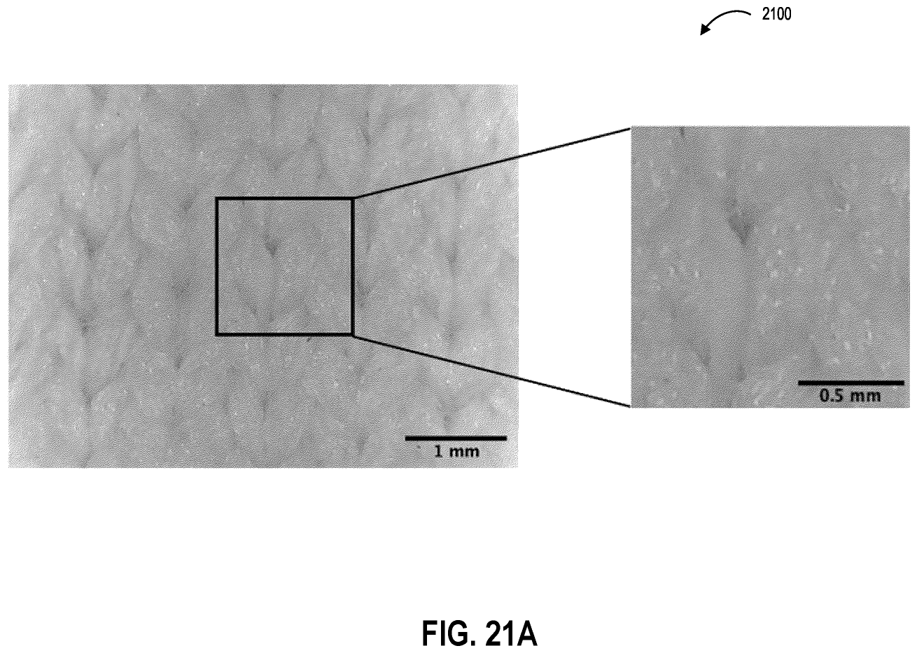

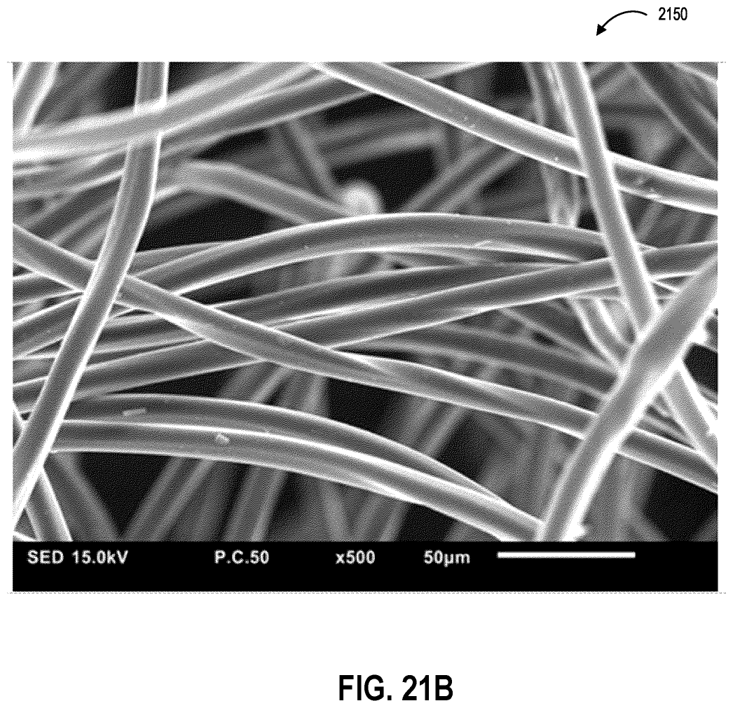

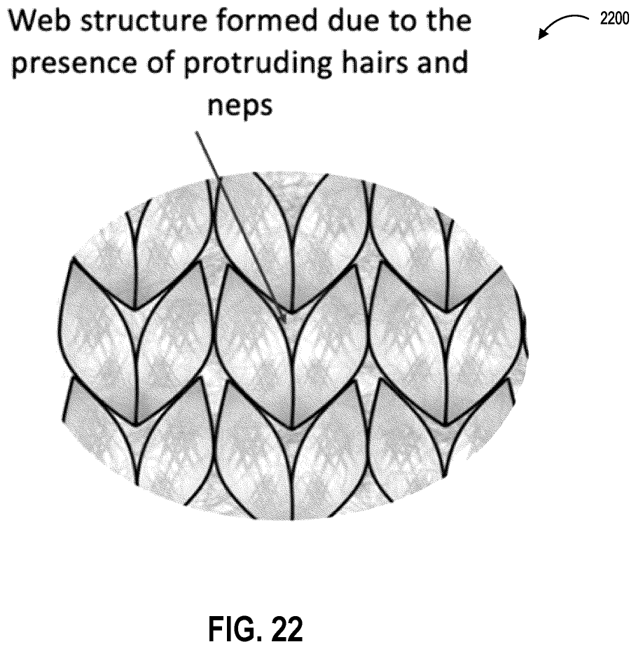

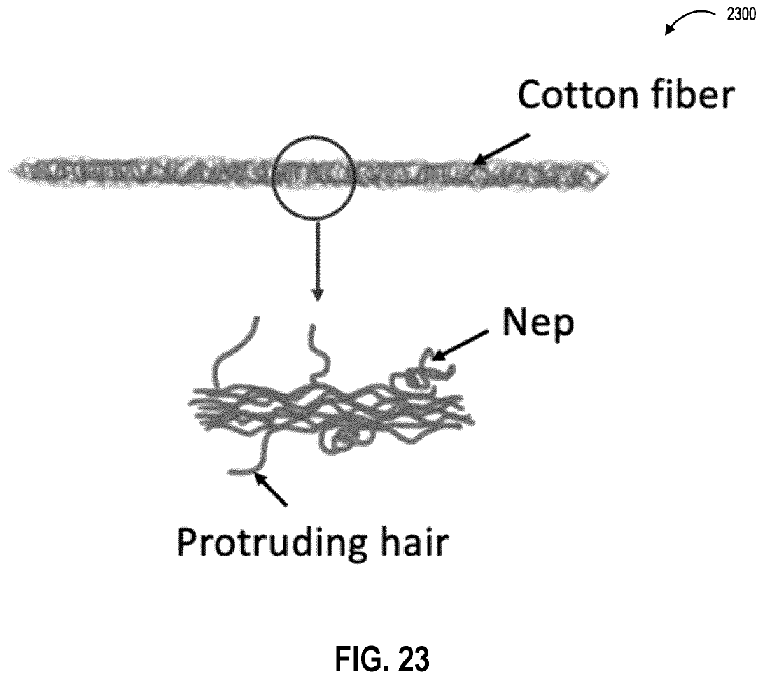

FIGS. 20A and 20B illustrate enlarged views of a sample cotton textile 2000 and a scanning electron microscope image 2050 of the sample cotton textile, in accordance with embodiments of the present disclosure. FIGS. 21A and 21B illustrate enlarged views of a combination cotton+nylon textile 2100 and a scanning electron microscope image 2150 of the combination cotton+nylon textile, in accordance with embodiments of the present disclosure. FIG. 22 illustrates a schematic 2200 of a fabric knitted based on natural fibers, in accordance with embodiments of the present disclosure. FIG. 23 illustrates a schematic 2300 of a cotton fiber showing neps and hair, in accordance with embodiments of the present disclosure.

In some scenarios, synthetic-based fibers such as Nylon and Polyester have a more uniform shape and a relatively small variability in width [23]. Higher number of neps and protruding hair (see e.g., FIGS. 20A, 20B, 21A, 21B, 22, and 23) may provide a fiber-web enhancing particle filtration based on diffusion, interception, and impaction mechanisms. Compared to samples knitted with synthetic fibers, natural fibers result in a nep or a web-like structure which is believed to enhance the filtration by both disrupting the gas streamlines and increasing the interaction surface area [23].

As an non-limiting example, facial garment textile sample 3C may be configured to include a smaller number of synthetic fibers and may exhibit a higher filtration efficiency due to formation of a web-filter media.

Based on the foregoing description herein, configuring facial garment textiles with one or more synthetic fibers may improve the filtration efficiency associated with small sized particles based, at least in part, on enhanced electrostatic filtration mechanisms, but may result in an overall lower filtration efficiency based, at least in part, on an absence of a nep or a web textural structure.

### Influence of Material Yarn Count and Thickness on the Filtration Efficiency

Example facial garment textile samples described herein may be configured with similar inner layer and outer layer composition. With these example textile samples, yarn count may be determined and compared for the inner layer only when yarn count is investigated for impact on overall facial garment filtration efficiency.

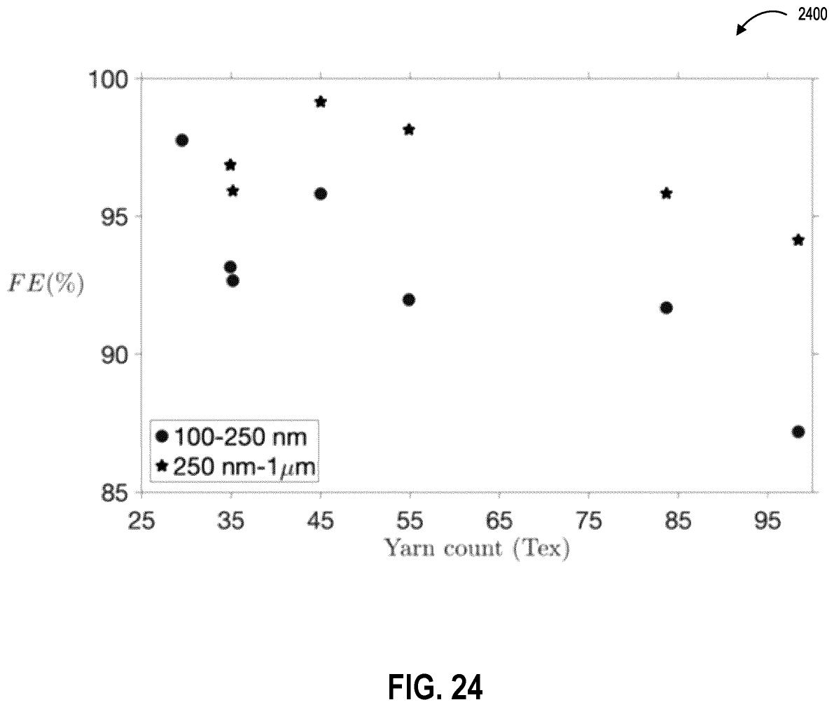

Reference is made to FIG. 24, which illustrates a chart 2400 showing data plots of yarn count and filtration efficiency of a plurality of textile samples, in accordance with embodiments of the present disclosure. When comparing the samples with varying yarn counts, there may be no general trends that may correlate filtration efficiency and the yarn count [24]. In some scenarios, while there may be an observable increase in pressure drop when yarn count increases, filtration efficiency may not increase with increasing yarn count. In some configurations, a higher textile yarn count may be associated with thinner fiber/threads, which may contribute to thinner textile samples and lower filtration efficiency.

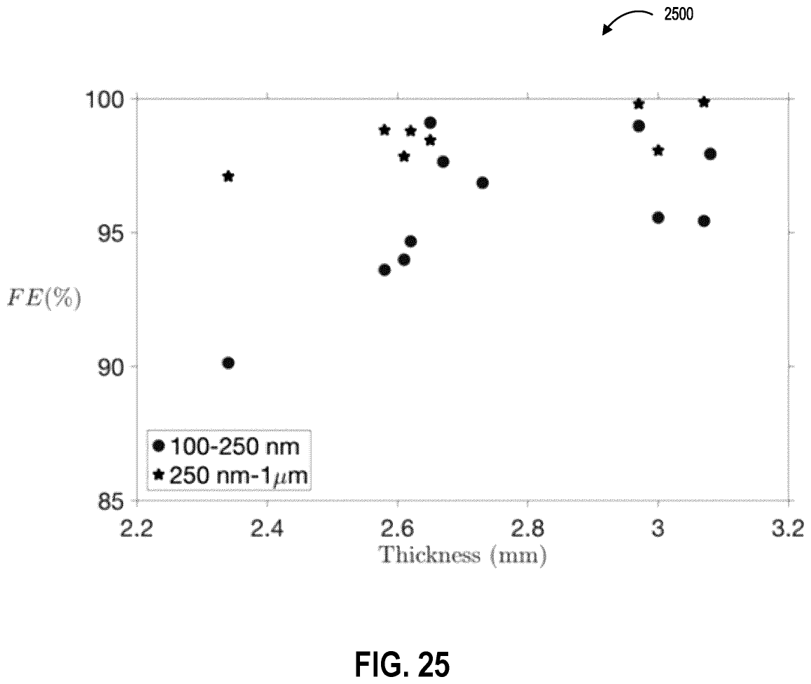

FIG. 25 illustrates a chart 2500 showing variation of textile filtration efficiency when varying textile thickness for textile samples a yarn count of 45.02 g/km. In some scenarios, it is believed that thicker textiles may result in higher filtration efficiency due to longer residence time. However, observations of experiments shown in FIG. 25 do not show any general trends that correlate textile thickness with textile filtration efficiency.

### The Influence of Sample Porosity and Stitch Length on the Sample Filtration Efficiency

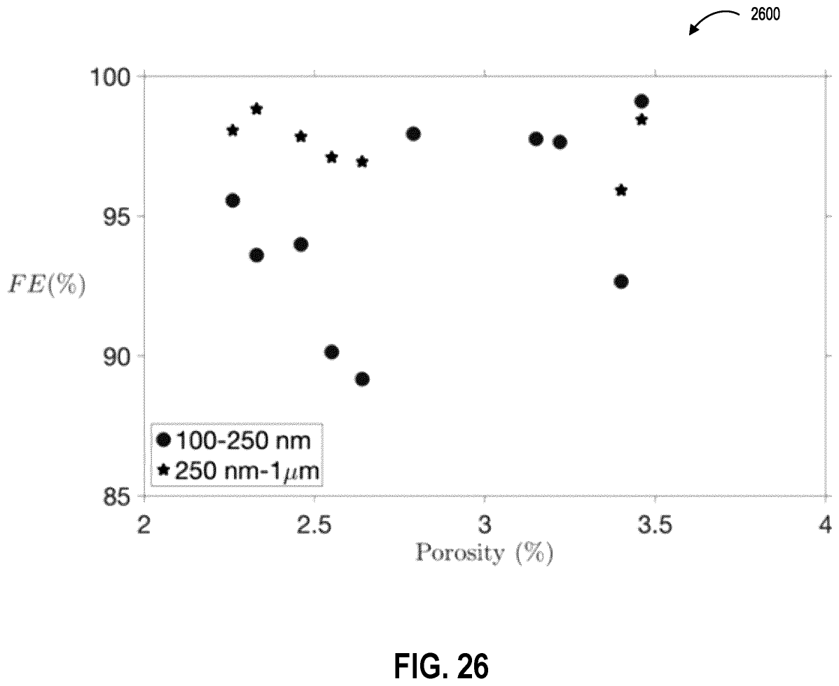

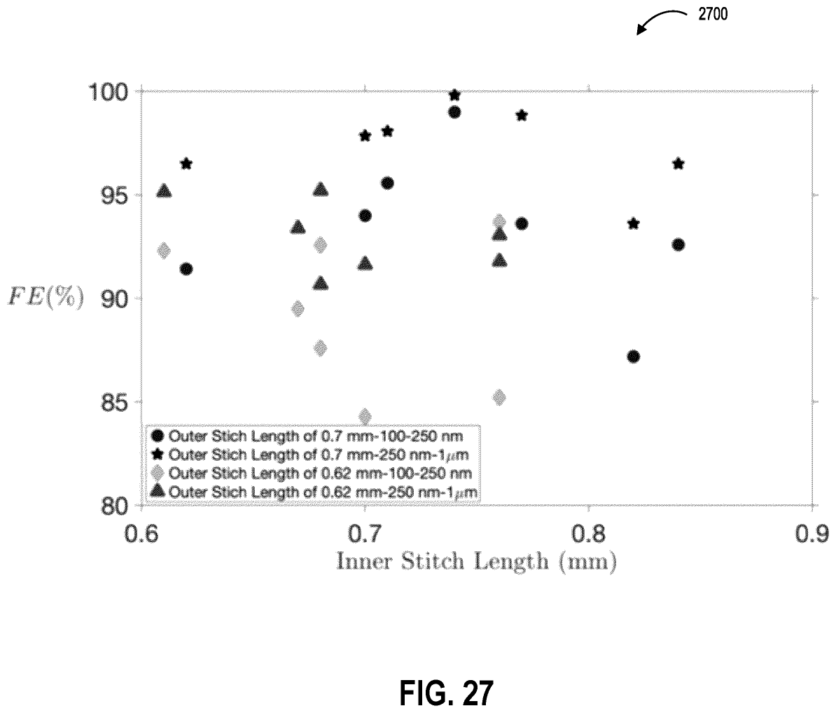

Reference is made to FIGS. 26 and 27, which illustrates charts (2600, 2700) showing textile test data of porosity and stich length, respectively to observed filtration efficiency, in accordance with embodiments of the present disclosure. Based on testing data summarized in FIGS. 26 and 27, stitch length and porosity associated with textiles may not predict textile filtration efficiency. The testing observations may be shown when determining textile filtration efficiency for relatively smaller sized particles.

As a non-limiting sample, when compared to textile sample 3C-1N-1, textile sample 3C-1N-4 was observed to have a higher filtration efficiency (94.7% for sample 3C-1N-1 and 99.1% for sample 3C-1N-4) despite the fact that textile sample 3C-1N-4 is configured with a looser knit structure and higher porosity (stitch length and porosity of 0.67 mm and 1.84% for sample 3C-1N-1 and 0.76 mm and 3.46% for sample 3C-1N-4). Further, textile sample 3C (having the greatest filtration efficiency) was not configured with the highest yarn count, does not have the smallest stitch length, and does not have the smallest porosity among the range of textile samples described in the present disclosure.

As there may be no observable trend among filtration efficiency and facial garment features associated with yarn materials, yarn count, or stitch length, there may be a complex relationship contributing to filtration efficiency of a facial garment textile. That is, in some scenarios, facial garments configured with a high yarn count, with small stich length and small porosity may not provide desirable filtration efficiency for smaller sized particles.

Based on testing observations described in the present disclosure, some embodiment facial garments configured with nep or web structures may contribute to improving filtration efficiency.

### The Effect of Laundering on the Sample Performance

It may be beneficial to provide facial garments configured with textiles to have a desired filtration efficiency (for filtering or blocking particle movement), a specified pressure drop value across the textile to promote breathability, while being reusable and washable.

In some scenarios, facial garments laundered via 4 wash cycles may exhibit a 20% reduction of filtration efficiency [40]. In this example, the reduction in filtration efficiency may have been attributed to change in textile pore size or shape. It may be beneficial to provide facial garments that may be laundered for numerous cycles without degradation in the facial garment filtration efficiency or pressure drop properties across the facial garment textile.

As described in the present disclosure, facial garment sample 3C includes a configuration having a desirable combination of filtration efficiency and pressure drop characteristics. To evaluate the extent that desirable facial garment properties may degrade, facial garment sample 16 was evaluated following a series of 10, 20, 30, 40, and 50 wash cycles. Each wash cycle included laundering for 35 minutes at 60 degrees Celsius temperature and drying for 40 minutes at 60 degrees Celsius temperature.

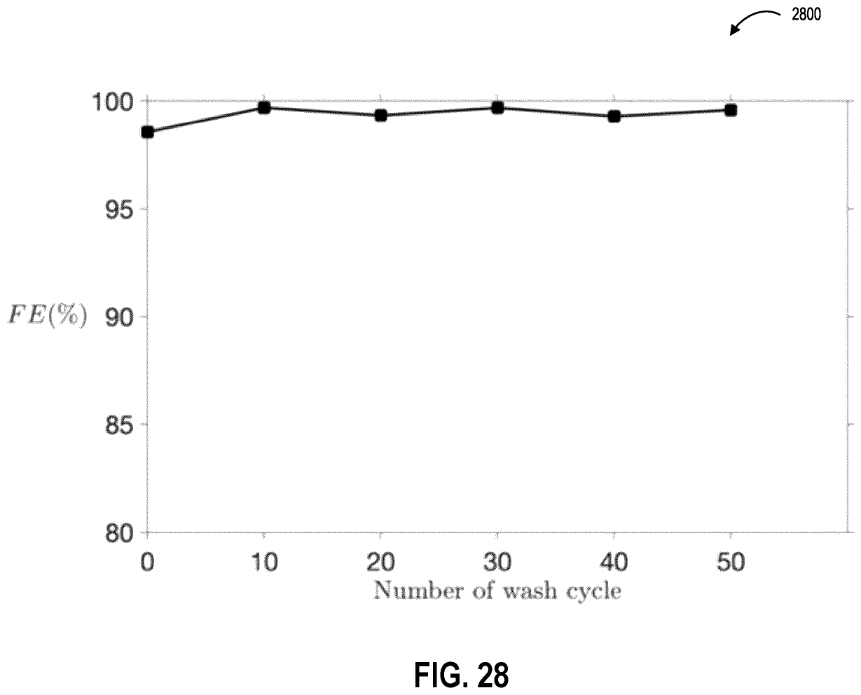

In the above-described experiments, wash cycles altered the facial garment performance in different ways for differently sized particles. For example, the wash cycles affected the mask performance differently for particles sized in the range of 100-250 nm and for particles sized 250 nm to 1 μm. In particular, after a plurality of wash cycles, filtration efficiency of the laundered facial garment increased when tested for filtration of larger sized particles, as illustrated in FIG. 28. FIG. 28 illustrates a chart 2800 showing filtration efficiency for particle sizes having a size range of 250 nm to 1 μm over a number of wash cycles.

To understand the effect of repetitive wash and dry cycles on filtration efficiency metrics for facial garments, a plurality of textile characteristics were evaluated following the laundering cycles. For example, after sample 3C was laundered, sample size was obtained and compared to sample size measures prior to the laundering cycles. In the present example, following the laundering cycles, sample 3C exhibited a 6.74% shrinkage after an initial 10 wash cycles. The sample size was observed to remain substantially the same after further wash cycles beyond 10. In the present example, the facial garment textile may have shrunk following the first 10 wash cycles, thereby contributing to enhanced filtration efficiency. Decreasing distance between textile fibers (due to wash cycles) may contribute to increased effectiveness for blocking larger sized particles. That is, shrinking of the sample after a few wash cycles may enhance the efficiency of the interception mechanism: the decrease in the distance between the fibers makes the sample more effective in terms of large particle retention or removal.

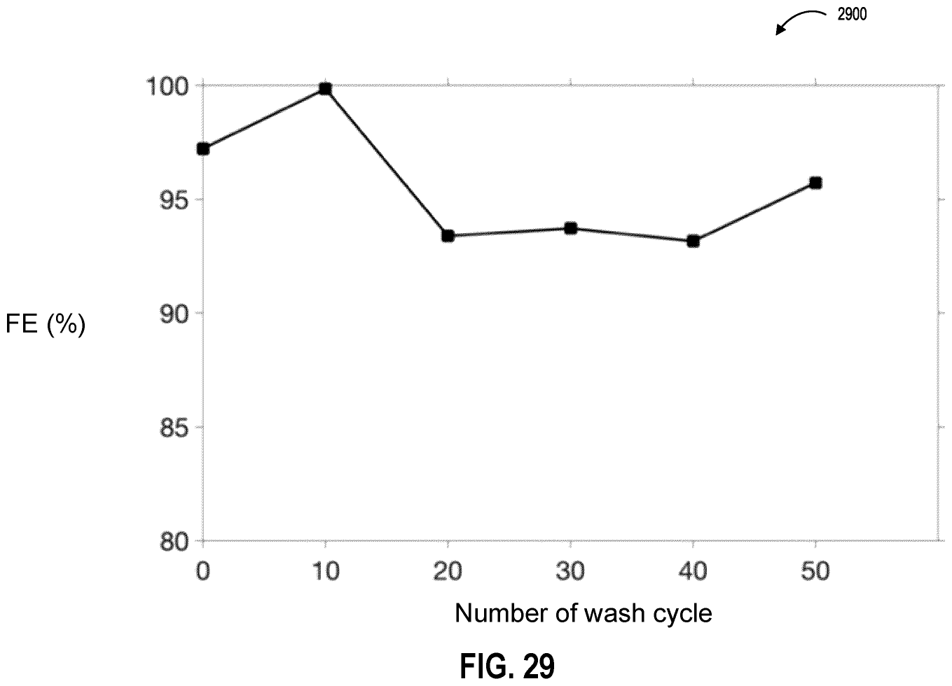

Although sample 3C exhibited improved filtration efficiency for larger sized particles following numerous laundering cycles, the filtration efficiency associated with smaller sized particles: (a) remained substantially the same after the initial laundering cycles; and (b) decreased by approximately 2.4% after 50 laundering cycles. FIG. 29 illustrates a chart 2900 showing filtration efficiency for particle sizes having a size range of 100 to 250 nm over a number of wash cycles. Accordingly, there may be minimal reduction in filtration efficiency with respect to smaller sized particles for facial garments (e.g., sample 3C) following numerous laundering cycles.

When considering changes to pressure drop characteristics of facial garment textiles following numerous laundering cycles, experiments conducted showed that the pressure drop characteristics for all facial garment samples increased by approximately 17% following the first 10 to 20 laundering cycles. There was no observable change associated with the pressure drop characteristics after laundering cycles beyond 20 cycles. The above-described experiments illustrate that laundering facial garment textiles may generally reduce the breathability of the respective facial garments that were tested.

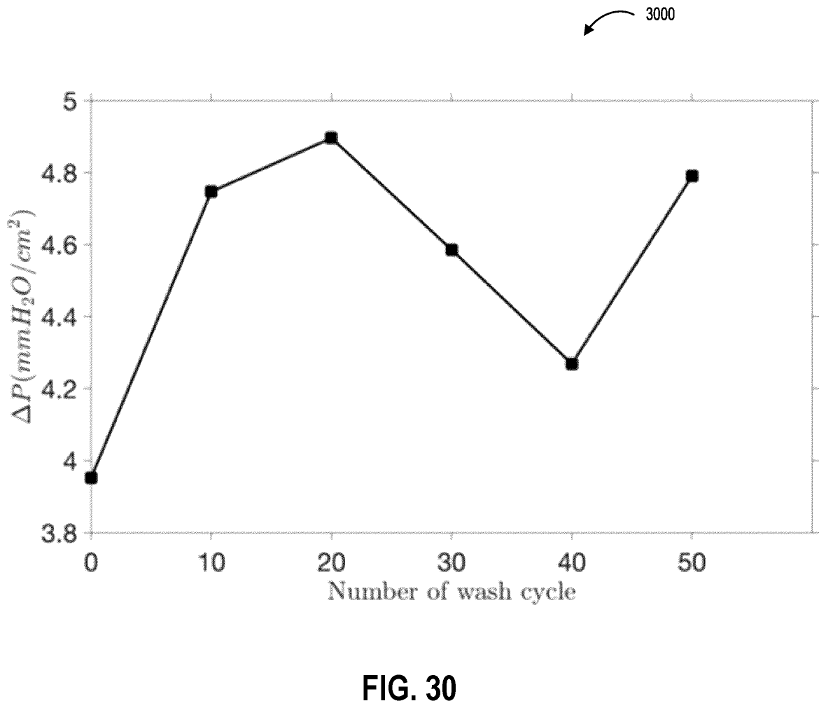

FIG. 30 illustrates a chart 3000 showing pressure drop as a function of number of wash cycles.

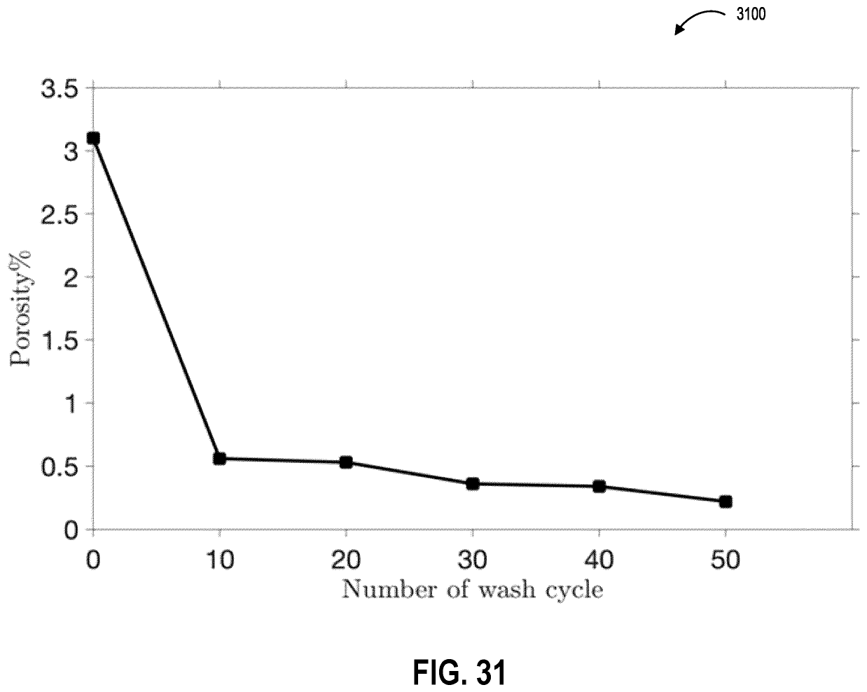

In some scenarios, the increase in pressure drop characteristic may be attributed to shrinking of the washed samples (e.g., associated with textile shrinkage). As shown in FIG. 31, the sample porosity may decrease: the porosity may be observed to decrease from 3.15% to 0.3% after 50 wash cycles. FIG. 31 illustrates a chart 3100 showing porosity as a function of number of wash cycles. For example, after 30 wash/dry cycles, a sample pressure drop may decrease and tend to the pressure drop of an unwashed sample.

Although the above described desirable facial garment (e.g., sample 3C) was shown to exhibit a relatively higher pressure drop characteristic following laundering cycles, the exhibited pressure drop characteristic following the laundering cycles may be still less than 5 mmH₂O/cm², which may be the requirement provided by ASTM F2100 for Level 1 masks.

In the present disclosure, pressure drop and filtration efficiency of 20 mask samples for particles having a particle size in the range of 100 nm-1 μm was described. Embodiments of facial garments may include 3 layers, including an inner layer being knitted out of pure cotton, cotton/polyester, or cotton/nylon, and middle/interconnecting and outer layer being knitted out of Lycra™ and super-hydrophobic polyester yarn, respectively. In some embodiments, facial garments described herein may have substantially similar composition for the middle/interconnecting and outer layers. The embodiments described herein, the inner layer configurations may differ based on yarn combination, stitch lengths (0.58-0.79 mm), or porosity properties.

Pressure drop, measured at air face velocity of 25 cm/s, may linearly increase with yarn count: 3.72 mmH₂O/cm² and 6.1 mmH₂O/cm² for samples with yarn count of 30 and 100 Tex, respectively. Further, the pressure drop may be higher for samples with shorter stitch lengths, lower porosities, and higher number of cotton ends. In some scenarios, substantially little correlation may be observed between the sample thickness and pressure drop.

In some embodiments, the relation between the filtration efficiency and fiber type, stitch length and porosity may be complex. Further, facial device samples may exhibit different performance characteristics when comparing test results based on smaller particle sizes (100-250 nm) and larger particle sizes (250 nm-1 μm). The filtration efficiency may be measured using light scattering at air face velocity of 7 cm/s. In some testing scenarios described herein, reported test results are based on leak-free conditions. The filtration efficiency of large particle (250 nm-1 μm) may be higher than 97% for all the tested samples. The filtration efficiency of relatively smaller particles (100-250 nm) may be lower (e.g., range of 89-98%). In some scenarios, the most penetrating particle size (MPPS) may be in a range between 50 nm and 500 nm for all the tested samples and may be lower for samples with higher porosities.

Test results described herein suggest that there may be an optimum number of cotton ends that maximize the filtration efficiency. For example, in some scenarios, the optimal number of cotton ends may be 3. The filtration efficiency of 100-250 nm and 250 nm-1 μm is 90.9% and 96.4% for the sample with 2 cotton ends and 96% and 99.1% for samples with 3 cotton ends, respectively.

Further increase in the number of cotton ends may result in a decreased filtration efficiency due to weakened web structure. The addition of synthetic fiber may manifest a dual effect on the filtration efficiency: synthetic fibers may improve the filtration efficiency due to enhanced electrostatic attraction while it may reduce the efficiency as a result of less disordered web structure and lower number of protruding fibers.

In some scenarios, there may be no general trend between the filtration efficiency and sample yarn count, thickness, stitch length and porosity and the dependence of the filtration efficiency on these parameters is complicated.

Embodiments of sample 3C (with inner layer of 3× cotton-outer layer of 1× nylon wrapped lycra and outer layer of 2× Super-hydrophobic Polyester-inner stitch length of 0.61 mm and outer stitch length of 0.58 mm-porosity of 3.15%) have shown to have the highest quality factor, 4.77 kPa⁻¹ (filtration efficiency of 97.8% for fine particles and pressure drop of 4.05 mmH₂O/cm²). Importantly, the filtration efficiency of sample 3C may be substantially invariant with particle size. The effect of laundering on sample 3C is described herein. The results show that after 50 wash/dry cycles, the filtration efficiency of large particles may improve by 2% while that of fine particles may decrease by 1.5%. The sample pressure drop after wash/dry cycles increases and the highest pressure drop was observed after 20 wash/dry cycles, which may still be lower than 5 mmH₂O/cm², the value recommended by ASTM F2100 for Level 1 masks.

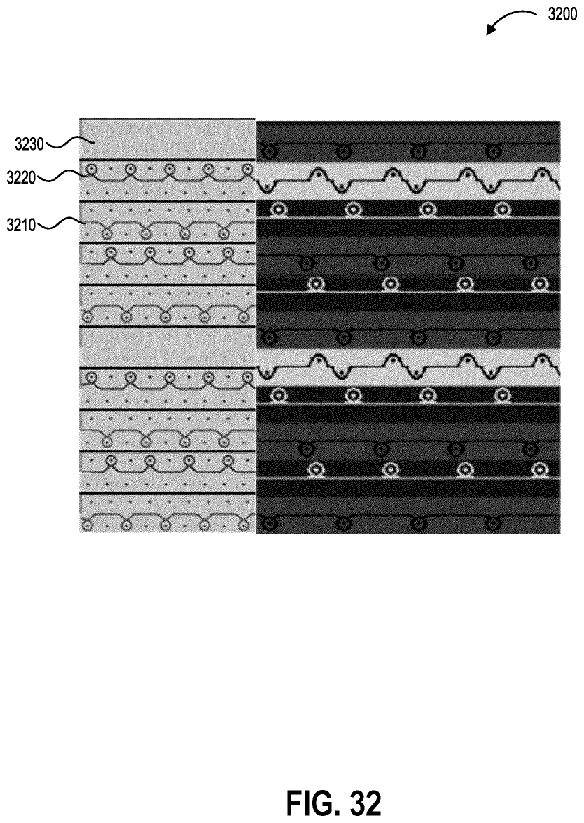

Reference is made to FIG. 32, which illustrates a sample knitting notation diagram 3200, in accordance with embodiments of the present disclosure. For example, the sample knitting notation diagram may include notations representing the hydrophobic polyester textile 3210 (e.g., red colour in diagram) used for an outer facial garment layer. The sample knitting notation diagram may include notations representing multi-ends of cotton 3220 (e.g., dark blue colour in diagram) plated with at least one end of an interconnecting or middle layer. The sample knitting notation diagram may include notations representing an interconnecting or middle layer 3230 (e.g., light blue colour in diagram). In some embodiments, an interconnecting layer may include Lycra™ based material.

Other knitting notation configurations may be contemplated.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter.

Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As can be understood, the examples described above and illustrated are intended to be exemplary only.

### REFERENCES

Xie, M.; Chen, Q. Insight into 2019 Novel Coronavirus—An Updated Interim Review and Lessons from SARS-CoV and MERS-CoV. International Journal of Infectious Diseases 2020, 94, 119-124. https://doi.org/10.1016/j.ijid.2020.03.071.
(2) Cui, J.; Li, F.; Shi, Z.-L. Origin and Evolution of Pathogenic Coronaviruses. Nat Rev Microbiol 2019, 17 (3), 181-192. https://doi.org/10.1038/s41579-018-0118-9.
(3) Zheng, Y.-Y.; Ma, Y.-T.; Zhang, J.-Y.; Xie, X. COVID-19 and the Cardiovascular System. Nat Rev Cardiol 2020, 17 (5), 259-260. https://doi.org/10.1038/s41569-020-0360-5.
(4) Dbouk, T.; Drikakis, D. On Respiratory Droplets and Face Masks. Physics of Fluids 2020, 32 (6), 063303. https://doi.org/10.1063/5.0015044.
(5) Bai, Y.; Yao, L.; Davoren A. Presumed Asymptomatic Carrier Transmission of COVID-19. JAMA 2020, 323 (14), 1407. https://doi.org/10.1001/jama.2020.0875.
(6) Leonas, K. K.; Hall, D. The Relationship of Fabric Properties and Bacterial Filtration Efficiency for Selected Surgical Face Masks. 2003, 3 (2), 9.
(7) Gralton, J.; Tovey, E.; McLaws, M.-L.; Rawlinson, W. D. The Role of Particle Size in Aerosolised Pathogen Transmission: A Review. Journal of Infection 2011, 62 (1), 1-13. https://doi.org/10.1016/j.jinf.2010.11.010.
(8) Bake, B.; Larsson, P.; Ljungkvist, G.; Ljungstr6 m, E.; Olin, A.-C. Exhaled Particles and Small Airways. Respir Res 2019, 20 (1), 8. https://doi.org/10.1186/s12931-019-0970-9.
(9) Morawska, L.; Johnson, G. R.; Ristovski, Z. D.; Hargreaves, M.; Mengersen, K.;
Corbett, S.; Chao, C. Y. H.; Li, Y.; Katoshevski, D. Size Distribution and Sites of Origin of Droplets Expelled from the Human Respiratory Tract during Expiratory Activities. Journal of Aerosol Science 2009, 40 (3), 256-269. https://doi.org/10.1016/j.jaerosci.2008.11.002.
(10) Parienta, D.; Morawska, L.; Johnson, G. R.; Ristovski, Z. D.; Hargreaves, M.; Mengersen, K.; Corbett, S.; Chao, C. Y. H.; Li, Y.; Katoshevski, D. Theoretical Analysis of the Motion and Evaporation of Exhaled Respiratory Droplets of Mixed Composition. Journal of Aerosol Science 2011, 42 (1), 1-10. https://doi.org/10.1016/j.jaerosci.2010.10.005.
(11) Chaudhuri, S.; Basu, S.; Kabi, P.; Unni, V. R.; Saha, A. Modeling the Role of Respiratory Droplets in Covid-19 Type Pandemics. Physics of Fluids 2020, 32 (6), 063309. https://doi.org/10.1063/5.0015984.
(12) Perid, R.; Perid, M. Analytical and Numerical Investigation of the Airflow in Face Masks Used for Protection against COVID-19 Virus—Implications for Mask Design and Usage. JAFM 2020, 13 (06). https://doi.org/10.47176/jafm.13.06.31812.
(13) Yan, J.; Grantham, M.; Pantelic, J.; Ehrman, S.; Milton, D. K. Infectious Virus in Exhaled Breath of Symptomatic Seasonal Influenza Cases from a College Community. 6.
(14) Liu, Y.; Ning, Z.; Chen, Y.; Guo, M.; Liu, Y.; Gali, N. K.; Sun, L.; Duan, Y.; Cai, J.; Westerdahl, D.; Liu, X.; Xu, K.; Ho, K.; Kan, H.; Fu, Q.; Lan, K. Aerodynamic Analysis of SARS-CoV-2 in Two Wuhan Hospitals. Nature 2020, 582 (7813), 557-560. https://doi.org/10.1038/s41586-020-2271-3.
(15) van Doremalen, N.; Bushmaker, T.; Morris, D. H.; Holbrook, M. G.; Gamble, A.; Williamson, B. N.; Tamin, A.; Harcourt, J. L.; Thornburg, N. J.; Gerber, S. I.; Lloyd-Smith, J. O.; de Wit, E.; Munster, V. J. Aerosol and Surface Stability of SARS-CoV-2 as Compared with SARS-CoV-1. N Engl J Med 2020, 382 (16), 1564-1567. https://doi.org/10.1056/NEJMc2004973.
(16) Health Emergencies Preparedness and Response Team. Advice on the Use of Masks in the Context of COVID-19: Interim Guidance, 5 Jun. 2020; WHO, 2020.
(17) Pramod Kulkarni; Baron, P. A.; Willeke, K. Aerosol Measurement: Principles, Techniques and Applications. 3rd Ed.; John Wiley & Sons, Inc.: Hoboken, N J, 2011; 107-128, 3rd ed.; John Wiley & Sons, Inc.: Hoboken, N J, 2011.
(18) Hinds, William. C. Aerosol Technology: Properties, Behavior, and Measurement Of Airborne Particles, 2nd ed.; John Wiley & Son.
(19) Vincent, J. H. Aerosol Sample Applications and Field Studies. In Aerosol Sampling. Science, Standards, Instrumentation and Applications; Vincent, J. H., Ed.; John Wiley & Sons: New York, 2007.
(20) H. Y. Chung, Book Review, Electrospinning of Micro- and Nanofibers: Fundamentals in Separation and Filtration Processes, SAGE Publications Sage UK, London, England, 2008.
(21) Stechkina, I.; Fuchs, N. Studies on Fibrous Aerosol Filters-I. Calculation of Diffusional Deposition of Aerosols in Fibrous Filters. Ann. Occup. Hyg. 1966, 9,59-64.
(22) Romay, F. J.; Liu, B. Y. H.; Chae, S.-J. Experimental Study of Electrostatic Capture Mechanisms in Commercial Electret Filters. Aerosol Science and Technology 1998, 28 (3), 224-234. https://doi.org/10.1080/02786829808965523.
(23) Zangmeister, C. D.; Radney, J. G.; Vicenzi, E. P.; Weaver, J. L. Filtration Efficiencies of Nanoscale Aerosol by Cloth Mask Materials Used to Slow the Spread of SARS-CoV-2. ACS Nano 2020, 13.
(24) Konda, A.; Prakash, A.; Moss, G. A.; Schmoldt, M.; Grant, G. D.; Guha, S. Aerosol Filtration Efficiency of Common Fabrics Used in Respiratory Cloth Masks. ACS Nano 2020, 14 (5), 6339-6347. https://doi.org/10.1021/acsnano.0c03252.
(25) Colbeck, I.; Lazaridis, M. Aerosol Science: Technology and Applications, 1st Ed.; Colbeck, I., Lazaridis, M., Eds.; John Wiley & Sons: New York, 2014; Pp 89-118, 1st ed.; John Wiley & Sons: New York, 2014.
(26) Brown, R.; Wake, D. Air Filtration by Interception-Theory and Experiment. J. Aerosol Sci. 1991, 22, 181-186.
(27) Emi, H.; Okuyama, K.; Yoshioka, N. Prediction of Collection Efficiency of Aerosols by High-Porosity Fibrous Filter. J. Chem. Eng. Jpn. 1973, 6, 349-354.
(28) Stechkina, I.; Kirsch, A.; Fuchs, N. Studies on Fibrous Aerosol Filters-IV Calculation of Aerosol Deposition in Model Filters In the Range of Maximum Penetration. Ann. Occup. Hyg. 1969, 12,1-8.
(29) Lee, K.; Liu, B. Theoretical Study of Aerosol Filtration by Fibrous Filters. Aerosol Sci. Technol. 1982, 1, 147-161.
(30) Martin, S. B.; Moyer, E. S. Electrostatic Respirator Filter Media: Filter Efficiency and Most Penetrating Particle Size Effects. Applied Occupational and Environmental Hygiene 2000, 15 (8), 609-617. https://doi.org/10.1080/10473220050075617.
(31) N. McCullough, L. Brosseau, D. Vesley, Collection of Three Bacterial Aerosols by Respirator and Surgical Mask Filters under Varying Conditions of Flow and Relative Humidity, Ann. Occup. Hyg. 41 (6) (1997) 677-690.
(32) A. W. Richardson, J. P. Eshbaugh, K. C. Hofacre, P. D. Gardner, Respirator Filter Efficiency Testing against Particulate and Biological Aerosols under Moderate to High Flow Rates, BATTELLE MEMORIAL INST COLUMBUS OH, 2006.
(33) Tcharkhtchi, A.; Abbasnezhad, N.; Zarbini Seydani, M.; Zirak, N.; Farzaneh, S.; Shirinbayan, M. An Overview of Filtration Efficiency through the Masks: Mechanisms of the Aerosols Penetration. Bioactive Materials 2021, 6 (1), 106-122. https://doi.org/10.1016/j.bioactmat.2020.08.002.
(34) Xiao, X.; Qian, L. Investigation of Humidity-Dependent Capillary Force. Langmuir 2000, 16 (21), 8153-8158. https://doi.org/10.1021/la0007700.
(35) Cf. D. Control, Prevention, MMWR. Morbidity and Mortality Weekly Report, Vol. 47, 1998, Pp. 1045-1049.
(36) Batazy, A.; Toivola, M.; Adhikari, A.; Sivasubramani, S. K.; Reponen, T.; Grinshpun, S. A. Do N95 Respirators Provide 95% Protection Level against Airborne Viruses, and How Adequate Are Surgical Masks? American Journal of Infection Control 2006, 34 (2), 51-57. https://doi.org/10.1016/j.ajic.2005.08.018.
(37) Leung, N. H. L.; Chu, D. K. W.; Shiu, E. Y. C.; Chan, K.-H.; McDevitt, J. J.; Hau, B. J. P.; Yen, H.-L.; Li, Y.; Ip, D. K. M.; Peiris, J. S. M.; Seto, W.-H.; Leung, G. M.; Milton, D. K.; Cowling, B. J. Respiratory Virus Shedding in Exhaled Breath and Efficacy of Face Masks. Nat Med 2020, 26 (5), 676-680. https://doi.org/i0.1038/s41591-020-0843-2.
(38) Milton, D. K.; Fabian, M. P.; Cowling, B. J.; Grantham, M. L.; McDevitt, J. J. Influenza Virus Aerosols in Human Exhaled Breath: Particle Size, Culturability, and Effect of Surgical Masks. PLoS Pathog 2013, 9 (3), e1003205. https://doi.org/10.1371/journal.ppat.1003205.
(39) Smith, J. D.; MacDougall, C. C.; Johnstone, J.; Copes, R. A.; Schwartz, B.; Garber, G. E. Effectiveness of N95 Respirators versus Surgical Masks in Protecting Health Care Workers from Acute Respiratory Infection: A Systematic Review and Meta-Analysis. CMAJ 2016, 188 (8), 567-574. https://doi.org/10.1503/cmaj.150835.
(40) Yao, B.; Wang, Y.; Ye, X.; Zhang, F.; Peng, Y. Impact of Structural Features on Dynamic Breathing Resistance of Healthcare Face Mask. Science of The Total Environment 2019, 689, 743-753. https://doi.org/10.1016/j.scitotenv.2019.06.463.
(41) Aragaw, T. A. Surgical Face Masks as a Potential Source for Microplastic Pollution in the COVID-19 Scenario. Marine Pollution Bulletin 2020, 159, 111517. https://doi.org/10.1016/j.marpolbul.2020.111517.
(42) Simple Respiratory Protection—Evaluation of the Filtration Performance of Cloth Masks and Common Fabric Materials Against 20-1000 Nm Size Particles. The Annals of Occupational Hygiene 2010. https://doi.org/i0.1093/annhyg/meq044.
(43) Davies, A.; Thompson, K.-A.; Giri, K.; Kafatos, G.; Walker, J.; Bennett, A. Testing the Efficacy of Homemade Masks: Would They Protect in an Influenza Pandemic? Disaster Medicine and Public Health Preparedness 7 (4), 6.
(44) Shakya, K. M.; Noyes, A.; Kallin, R.; Peltier, R. E. Evaluating the Efficacy of Cloth Facemasks in Reducing Particulate Matter Exposure. J Expo Sci Environ Epidemiol 2017, 27 (3), 352-357. https://doi.org/10.1038/jes.2016.42.
(45) Neupane, B. B.; Mainali, S.; Sharma, A.; Giri, B. Optical Microscopic Study of Surface Morphology and Filtering Efficiency of Face Masks. PeerJ 2019, 7, e7142. https://doi.org/10.7717/peerj.7142.
(46) Lustig, S. R.; Biswakarma, J. J. H.; Rana, D.; Tilford, S. H.; Hu, W.; Su, M.; Rosenblatt, M. S. Effectiveness of Common Fabrics to Block Aqueous Aerosols of Virus-like Nanoparticles. ACS Nano 2020, 14 (6), 7651-7658. https://doi.org/10.1021/acsnano.0c03972.
(47) Wang, J.; Du, G. COVID-19 May Transmit through Aerosol. Ir J Med Sci 2020, 189 (4), 1143-1144. https://doi.org/10.1007/si1845-020-02218-2.
(48) Wells, W. F. Airborne Contagion and Air Hygiene: An Ecological Study of Droplet Infections. J. Am. Med. Assoc. 1955, 159, 90.
(49) Mainelis, G.; Willeke, K.; Baron, P.; Grinshpun, S.; Reponen, T. Induction Charging and Electrostatic Classification of Micrometer-Size Particles for Investigating the Electrobiological Properties of Airborne Microorganisms. Aerosol Sci. Technol. 2002, 36, 479-491.
(50) Kellogg, W. H.; MacMillan, G. AN EXPERIMENTAL STUDY OF THE EFFICACY OF GAUZE FACE MASKS. Am J Public Health 1920, 10 (1), 34-42. https://doi.org/10.2105/AJPH.10.1.34.
(51) Podgórski, A.; Batazy, A.; Gradon, L. Application of Nanofibers to Improve the Flltration Efficiency of the Most Penetrating Aerosol Particles in Fibrous Filters. Chemical Engineering Science 2006, 12.
(52) Kowalski, W.; Bahnfleth, W.; Whittam, T. Filtration of Airborne Microorganisms: Modeling and Prediction. In AHRAE Transactions, Seattle WA, Jun. 18, 1999-Jun. 23, 1999; Geshwiler, M., Harrell, D., Roberson, T., Eds.; American Society of Heating, Refrigerating and Air-Conditioning Engineers, Inc.: Seattle, W A, 1999; Vol. 4273, Pp 4-17. (34).
(53) Schiefter, H.; Taft, D.; Porter, J. Effect of Number of Warp and Filling Yarns per Inch and Some Other Elements of Construction on the Properties of Cloth. J. Res. Natl. Bur. Stand. 1936, 16, 139-147.
(54) Lee, S.; Obendorf, S. K. Statistical Model of Pesticide Penetration Through Woven Work Clothing Fabrics. Arch Environ Contam Toxicol 2005, 49 (2), 266-273. https://doi.org/i0.1007/s00244-004-0127-8.
(55) Drewnick, F.; Pikmann, J.; Fachinger, F.; Moormann, L.; Sprang, F.; Borrmann, S. Aerosol Filtration Efficiency of Household Materials for Homemade Face Masks: Influence of Material Properties, Particle Size, Particle Electrical Charge, Face Velocity, and Leaks. Aerosol Science and Technology 2021, 55 (1), 63-79. https://doi.org/10.1080/02786826.2020.1817846.
(56) Zhao, M.; Liao, L.; Xiao, W.; Yu, X.; Wang, H.; Wang, Q.; Lin, Y. L.; Kilinc-Balci, F. S.; Price, A.; Chu, L.; Chu, M. C.; Chu, S.; Cui, Y. Household Materials Selection for Homemade Cloth Face Coverings and Their Filtration Efficiency Enhancement with Triboelectric Charging. Nano Lett. 2020, 20 (7), 5544-5552. https://doi.org/10.1021/acs.nanolett.0c02211.
(57) Payen, J.; Vroman, P.; Lewandowski, M.; Perwuelz, A.; Call6-Chazelet, S.; Thomas, D. Influence of Fiber Diameter, Fiber Combinations and Solid Volume Fraction on Air Filtration Properties in Nonwovens. Textile Research Journal 2012, 82 (19), 1948-1959. https://doi.org/10.1177/0040517512449066.
(58) Hosseini, S. A.; Tafreshi, H. V. On the Importance of Fibers' Cross-Sectional Shape for Air Filters Operating in the Slip Flow Regime. Powder Technology 2011, 212 (3), 425-431. https://doi.org/10.1016/j.powtec.2011.06.025.
(59) Alekseeva, L. V. Theoretical Aspects of Predicting the Electrostatic Properties of Textile Materials. Fibre Chem 2007, 39 (3), 225-226. https://doi.org/10.1007/s10692-007-0047-2.
(60) Zilinskas, P. J.; Lozovski, T.; Jankauskas, V.; Jurkšus, J. Electrostatic Properties and Characterization of Textile Materials Affected by Ion Flux. ms 2013, 19 (1), 61-66. https://doi.org/10.5755/j01.ms.19.1.3828.
(61) Grishanov, S. Structure and Properties of Textile Materials. In: Handbook of Textile and Industrial Dyeing: Principles, Processes and Types of Dyes. Elsevier Inc., Pp. 28e63; 2011.
(62) Bradow, J. M.; Davidonis, G. H. Quantitation of Fiber Quality and the Cotton Production-Processing Interface: A Physiologist's Perspective. 2000, 4 (1), 31.
(63) Bailey, B. Diameter Relationships of Wool Fibers from Five Breeds of Sheep Raised in South Dakota. J. Agric. Res. 1940, 60, 415-426.
(64) Stobart, R.; Russell, W.; Larsen, S.; Johnson, C.; Kinnison, J. Sources of Variation in Wool Fiber Diameter. J. Anim. Sci. 1986, 62, 1181-1186.
(65) Huang, S.-H.; Chen, C.-W.; Kuo, Y.-M.; Lai, C.-Y.; McKay, R.; Chen, C.-C. Factors Affecting Filter Penetration and Quality Factor of Particulate Respirators. Aerosol Air Qual. Res. 2013, 13 (1), 162-171. https://doi.org/10.4209/aaqr.2012.07.0179.
(66) Wang, J.; Kim, S. C.; Pui, D. Y. H. Investigation of the Figure of Merit for Filters with a Single Nanofiber Layer on a Substrate. Journal of Aerosol Science 2008, 39 (4), 323-334. https://doi.org/10.1016/j.jaerosci.2007.12.003.
(67) Wang, J.; Kim, S. C.; Pui, D. Y. H. Figure of Merit of Composite Filters with Micrometer and Nanometer Fibers. Aerosol Science and Technology 2008, 42 (9), 722-728. https://doi.org/10.1080/02786820802249133.

What is claimed is:

1. A facial garment comprising:
an outer hydrophobic textile for repelling moisture;
an inner textile proximal to the outer hydrophobic textile; and
an interconnecting structure coupling the outer hydrophobic textile and the inner textile, the interconnecting structure including nylon-wrapped, synthetic elastane fiber,
wherein the inner textile includes a natural fiber having one or more neps for increasing an interaction surface area for particles incident on the facial garment and for promoting turbulence among particles incident on the facial garment.

2. The facial garment of claim 1, wherein the natural fiber is devoid of synthetic fibers.

3. The facial garment of claim 1, wherein the inner textile includes up to 3-ended cotton ends.

4. The facial garment of claim 3, wherein the inner textile is a 3-ended cotton textile.

5. The facial garment of claim 3, wherein the inner textile includes 3× cotton textile, and wherein the outer hydrophobic textile 150 includes 2× super-hydrophobic polyester.

6. The facial garment of claim 1, wherein the natural fiber includes a range of cross-sectional fiber diameter variability in the range of 20 μm.

7. The facial garment of claim 1, wherein a stich length associated with the outer hydrophobic textile of 0.58 millimeters, and wherein a stitch length associated with the inner textile of 0.61 millimeters.

8. The facial garment of claim 1, wherein a thickness of the combined outer hydrophobic textile and the inner textile being substantially 2.67 millimeters, and wherein an areal mass of the combined outer hydrophobic textile and the inner textile being substantially 0.0245 g/cm².

9. The facial garment of claim 1, wherein the outer hydrophobic textile is configured to interact with an incident particle at an environment facing surface of the outer hydrophobic textile at a contact angle of substantially 160 degrees.

10. The facial garment of claim 1, wherein the interconnecting structure draws moisture in a unitary direction from the inner textile to the outer hydrophobic textile.

11. The facial garment of claim 1, comprising at least one of a nose bridge device or a chin bridge device for positioning the facial garment to contours of a user's face.

12. The facial garment of claim 1, wherein the inner textile includes a natural fiber having a web structure.
